(19) United States
(12) Patent Application Publication
(10) Pub. No.: US 2018/0122176 A1
(43) Pub. Date: May 3, 2018

(54) MEDIUM DISPENSING DEVICE AND MEDIUM DISPENSING SYSTEM

(71) Applicant: Oki Electric Industry Co., Ltd., Tokyo (JP)

(72) Inventors: Ryuji YOKOKURA, Tokyo (JP); Atsushi TAKADA, Tokyo (JP)

(73) Assignee: Oki Electric Industry Co., Ltd., Tokyo (JP)

(21) Appl. No.: 15/858,568

(22) Filed: Dec. 29, 2017

Related U.S. Application Data
(62) Division of application No. 14/894,206, filed on Nov. 25, 2015.

(30) Foreign Application Priority Data
May 30, 2013 (JP) 2013-114255

(51) Int. Cl. G07D 11/00; B65H 29/12; B65H 31/24

(52) U.S. Cl. CPC G07D 11/0021; G07D 11/0069; G07D 11/0066; G07D 11/0054; G07D 11/0051; B65H 2557/65; G07D 11/0036; B65H 31/24; B65H 2402/45; B65H 2551/27; B65H 29/12

(57) ABSTRACT

A medium dispensing device including a storage section that stores a sheet shaped medium, a conveying section that conveys the medium, plural dispensing ports that dispense the medium, an instruction reception section that receives from plural external terminal devices instructions related to dispensing the medium, a controller that, based on the instructions, feeds out the medium from the storage section and conveys the medium to a dispensing port using a conveying section, and a notification section that notifies a correspondence between the terminal device that the instruction is received from and the dispensing port for dispensing the medium. The notification section is equipped with a display section that displays characters, graphics, symbols, images, hue, or brightness, or a combination thereof.

### CROSS-REFERENCE TO RELATED APPLICATIONS

This application is a division of U.S. application Ser. No. 14/894,206, filed on Nov. 25, 2015, which was a National Stage application of PCT/JP2014/059772, filed on Apr. 2, 2014, and based on, and claims priority to, Japanese Patent Application No. 2013-114255, filed on May 30, 2013. The entire disclosures of these prior U.S. and foreign applications are incorporated herein by reference.

### TECHNICAL FIELD

The present invention relates to a medium dispensing device and medium dispensing system, and is suitably applied, for example, to a banknote processing device (called a teller machine) installed at a window of a financial institution.

### BACKGROUND ART

Hitherto, banknote processing devices have been in widespread use, performing various transaction processing such as paying in and paying out cash, from and to a customer, under operation of an operator such as a window employee (called a teller) at a window of a financial institution (see, for example, Japanese Patent Application Laid-Open (JP-A) No. 2011-198145).

Such banknote processing devices include, for example, a paying in section where banknotes are paid in, a pay-out section that pays out banknotes, a conveying section that conveys banknotes, a classification section that classifies input banknotes by denomination and authenticity, a temporary holding section that temporarily holds input banknotes, banknote cassettes that store banknotes by denomination, and a reject cassette that stores banknotes not suitable for re-use.

The banknote processing devices are connected to a terminal device operated by an operator, and execute various processing, such as pay-out processing, based on operation instructions from the terminal device.

For example, on receipt of a pay-out instruction from an operator via a terminal device, a banknote processing device feeds out banknotes from the banknote cassettes according to the amount to be paid out, and conveys the banknotes in sequence to the pay-out section using the conveying section. The pay-out section sequentially internally collects the banknotes that have been conveyed in one note at a time by the conveying section, and then pays out the banknotes to the operator when all the banknotes to be paid out have been collected.

### SUMMARY OF INVENTION

### Technical Problem

However, a banknote processing device is sometimes connected to plural terminal devices over a network or the like, and sometimes used while shared by plural operators operating the terminal devices.

However, when plural pay-out instructions are issued from each terminal device at the same time, the banknote processing device sequentially executes pay-out processing according to each of these pay-out instructions, making one of the operators wait.

In particular, when pay-out processing is being performed according to the pay-out instruction from one terminal device, the banknote processing device cannot start the next pay-out processing in a state where paid out banknotes remain in a pay-out port, even if a pay-out instruction has been received from another terminal device. This accordingly results in a wait until the banknotes are taken from the pay-out port by the operator, and an even longer waiting time.

Such banknote processing devices have the problem of a concern that an operator will be caused to wait a comparatively long time from actual receipt of a pay-out instruction, until the pay-out processing is complete and the banknotes have been passed across to the operator.

In consideration of the above circumstances, the present invention proposes a medium dispensing device and a medium dispensing system capable of dispensing a medium in a short period of time in response to instructions from plural terminal devices.

### Solution to Problem

In order to address the above issues, a medium dispensing device of the present invention includes: a storage section that stores a sheet shaped medium; a conveying section that conveys the medium; plural dispensing ports that dispense the medium; an instruction reception section that receives from plural external terminal devices instructions related to dispensing the medium; a controller that, based on the instructions, feeds out the medium from the storage section and conveys the medium to a dispensing port using a conveying section; and a notification section that notifies a correspondence between the terminal device that the instruction is received from and the dispensing port for dispensing the medium.

Moreover, a medium dispensing system of the present invention includes plural terminal devices that instruct dispensing of a sheet shaped medium, and a medium dispensing device that dispenses the medium based on instructions from the terminal devices. The medium dispensing device includes: a storage section that stores the medium; a conveying section that conveys the medium; plural dispensing ports that dispense the medium; an instruction reception section that receives from the external terminal devices instructions related to dispensing the medium; a controller that, based on the instructions, feeds out the medium from the storage section and conveys the medium to a dispensing port using a conveying section; and a communications section that sends to the terminal device that received the instruction information identifying the dispensing port from which the medium has been dispensed. The terminal devices each include: a terminal communication section that receives the information; and a terminal display section that, based on the information, displays information identifying the dispensing port to which the medium has been conveyed.

In the present invention, when instructions are respectively received from plural terminal devices, the waiting time from receipt of instruction to completing dispensing can be shortened due to conveying the medium to mutually different dispensing ports based on each instruction, and mistaken taking of the medium can be prevented before it occurs due to notifying the correspondence between the terminal device that the instruction is received from and the dispensing port.

### Advantageous Effects of Invention

According to the present invention, when instructions are respectively received from plural terminal devices, the waiting time from receipt of instruction to completing dispensing can be shortened due to conveying the medium to mutually different dispensing ports based on each instruction, and mistaken taking of the medium can be prevented before it occurs due to notifying the correspondence between the terminal device that the instruction is received from and the dispensing port. Thus the present invention enables a medium dispensing device and a medium dispensing system to be implemented that are capable of dispensing a medium in a shorter time when instructions are respectively received from plural terminal devices.

### BRIEF DESCRIPTION OF DRAWINGS

FIG. 1 is a schematic diagram illustrating an overall configuration of a banknote dispensing system.

FIG. 2 is schematic diagram illustrating a layout of a banknote processing device at a window.

FIG. 3 is a schematic perspective view illustrating an external configuration of a banknote processing device.

FIG. 4 is a schematic diagram illustrating a configuration of a pay-in/pay-out section of a first exemplary embodiment.

FIG. 5 is a schematic diagram illustrating a display screen for displaying on a display operation section.

FIG. 6 is a schematic diagram illustrating an internal configuration of a banknote processing device.

FIG. 7 is a flowchart illustrating a pay-in processing routine (1) in the first exemplary embodiment.

FIG. 8 is a flowchart illustrating a pay-in processing routine (2) in the first exemplary embodiment.

FIG. 9A is a schematic diagram illustrating a display screen in pay-in processing.

FIG. 9B is a schematic diagram illustrating a display screen in pay-in processing.

FIG. 9C is a schematic diagram illustrating a display screen in pay-in processing.

FIG. 9D is a schematic diagram illustrating a display screen in pay-in processing.

FIG. 10 is a flowchart illustrating pay-out processing in a first exemplary embodiment.

FIG. 11A is a schematic diagram illustrating a display screen in pay-out processing.

FIG. 11B is a schematic diagram illustrating a display screen in pay-out processing.

FIG. 11C is a schematic diagram illustrating a display screen in pay-out processing.

FIG. 12A is a schematic diagram illustrating a configuration of a message window.

FIG. 12B is a schematic diagram illustrating a configuration of a message window.

FIG. 13 is a flowchart illustrating a cover opening and closing processing routine of a first exemplary embodiment.

FIG. 14 is a schematic diagram illustrating a configuration of a pay-in/pay-out section according to a second exemplary embodiment.

FIG. 15 is a flowchart illustrating a pay-out processing routine of the second exemplary embodiment.

FIG. 16 is flowchart illustrating a cover opening and closing processing routine of the second exemplary embodiment.

FIG. 17 is a schematic diagram illustrating a display screen of another exemplary embodiment.

FIG. 18 is a schematic diagram illustrating a configuration of a pay-in/pay-out section of another exemplary embodiment.

### DESCRIPTION OF EMBODIMENTS

Explanation follows regarding embodiments for implementing the invention (referred to below as exemplary embodiments), with reference to the drawings.

### 1. First Exemplary Embodiment

1-1. Banknote Pay-Out System Configuration

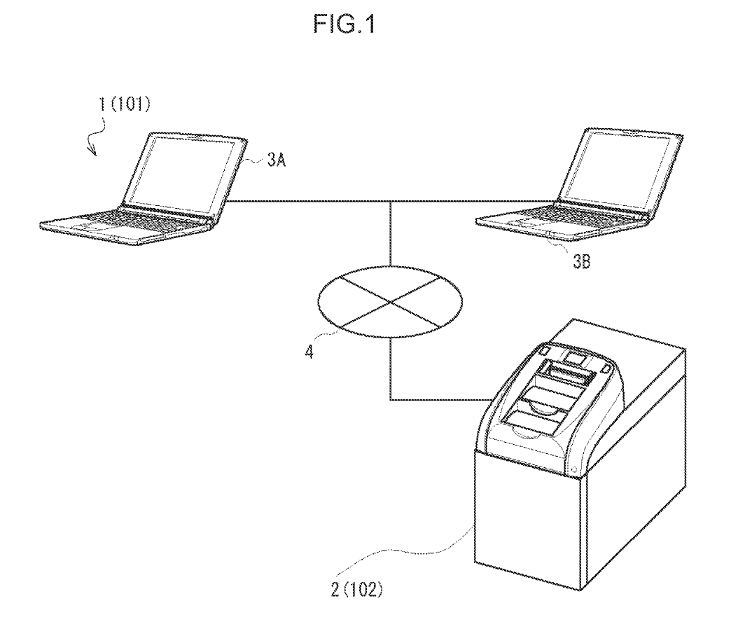

As illustrated in FIG. 1, a banknote pay-out system 1 according to the present exemplary embodiment has a configuration in which a single banknote processing device 2 and two terminal devices 3A and 3B (referred to collectively below as terminal devices 3) are connected together by a network 4.

The banknote processing device 2 is a cash processing device used at a window (called a teller machine) and installed at a window or the like of a financial institution, and performs pay-in processing and pay-out processing of banknotes under operation by operators, such as window staff dealing with customers at the window or the like.

Similarly to an ordinary computer, the terminal devices 3 each include a computation processor that performs various computation processing, a memory section that stores various information, an operation section including a keyboard, a touch panel, and the like, a display section that displays a display screen, a communication processing section that sends and receives information over the network, and the like.

The terminal devices 3A and 3B generate instructions for pay-in processing and pay-out processing according to operation of operators MA and MB, and send the instructions to the banknote processing device 2. In response, the banknote processing device 2 executes various processing according to the instructions, such as pay-in processing and pay-out processing.

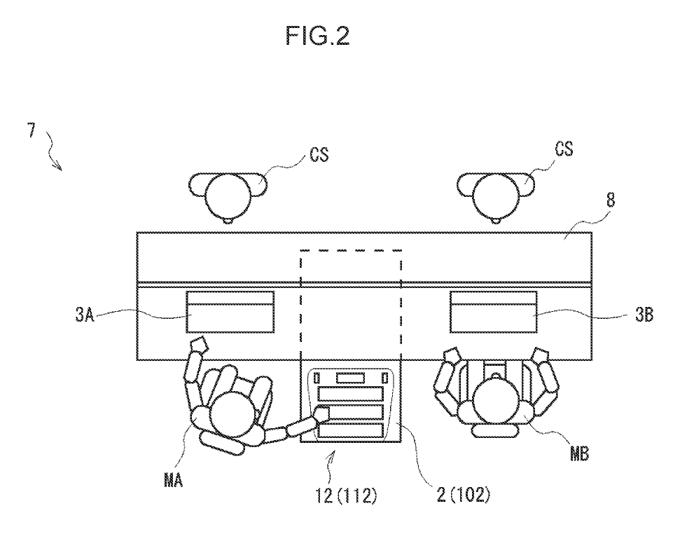

The banknote processing device 2 and the terminal devices 3 (3A and 3B) are, as illustrated in plan view in FIG. 2, installed, for example, at a window 7 of a financial institution. The window 7 is partitioned by a counter 8, at the center of the illustration installed such that its length direction lies along the left-right direction, into an area where the operators MA and MB (referred to collectively below as operators M) or the like who are staff of a financial institution perform clerical work (at the lower side of the diagram), and an area where visiting customers CS perform various transactions and procedures (at the upper side of the diagram).

In the window 7, the banknote processing device 2 is installed in a position such that its rear side section is inserted under the counter 8, and its front side section lies between the two operators MA and MB who are seated on chairs.

The terminal devices 3A and 3B operated by the respective operators MA and MB are installed on the counter 8, in positions facing the respective operators MA and MB.

1-2 Banknote Processing Device Configuration

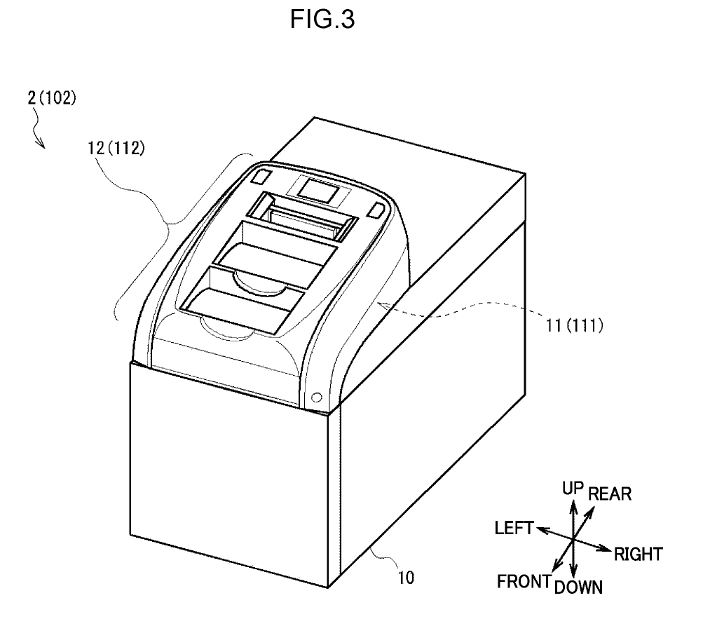

Explanation next follows regarding the configuration of the banknote processing device 2. As illustrated in the external configuration of FIG. 3, the banknote processing device 2 is provided with a controller 11 inside a case 10 formed in an overall rectangular box shape.

The controller 11 is configured around a central processing unit (CPU), and performs unified overall control, and various processing such as pay-in processing and pay-out processing by reading a specific program from ROM, flash memory, or the like, and executing the program.

The controller 11 internally includes random access memory (RAM), and a memory section such as a hard disk drive, flash memory, or the like, and various information, programs, and the like are stored in the memory section.

A pay-in/pay-out section 12 is provided on the upper face of the case 10, at a location toward the front, for passing over banknotes to and from the operators MA and MB. In consideration of being operated by the operators M who are working seated at the window 7 (see FIG. 2), the pay-in/pay-out section 12 projects out above its surroundings and is inclined such that its front side is lower.

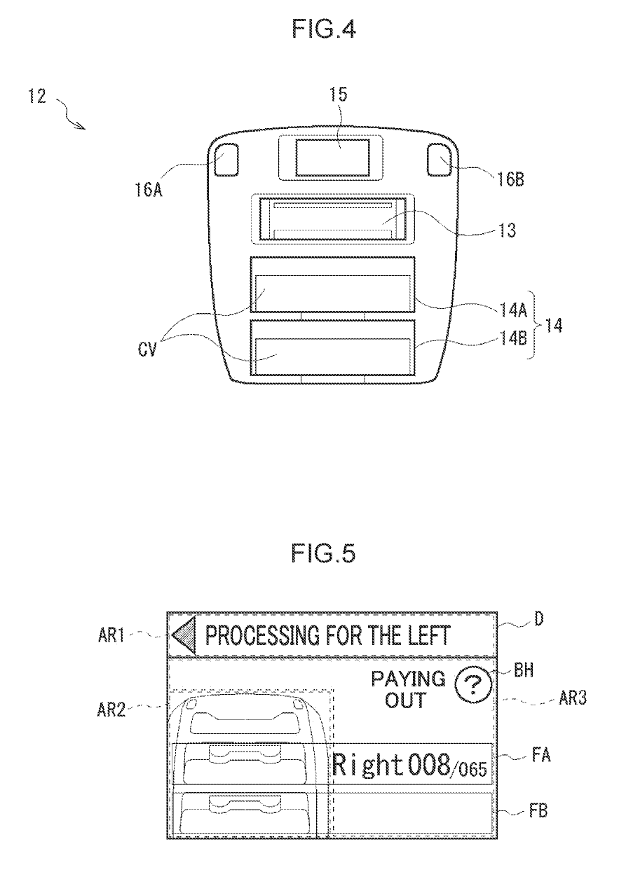

As illustrated in FIG. 4, a pay-out port 14B, a pay-out port 14A, a pay-in port 13, and a display operation section 15 are disposed on the pay-in/pay-out section 12 in sequence from the front side toward the rear side, and operation buttons 16A and 16B are respectively disposed at the left and right of the display operation section 15.

In the following explanation, the front face side of the banknote processing device 2 from which the display content of the display operation section 15 is correctly readable is defined as being at the front side, the opposite side thereto is defined as being at the rear side, the left and right as viewed from the front side are respectively designated as the left side and the right side, and an upper side and a lower side are defined.

The pay-in port 13 is mainly employed when banknotes are paid in. When banknotes have been inserted into a pay-in space inside the pay-in port 13 by the operators M, the inserted banknotes are separated one note at a time and drawn into the banknote processing device 2. A banknote detection sensor, for example, a light blocking sensor, is provided in the pay-in port 13, and whether or not there are one or more banknotes present inside the pay-in space is detected, and the detection result is transmitted to the controller 11.

The pay-out ports 14A and 14B (collectively referred to below as pay-out ports 14) are mainly employed when banknotes are paid out and when banknotes need to be returned to the operators M in various processing, and banknotes conveyed in from inside the banknote processing device 2 are collected in an internal collection space, and taken by the operators M. The pay-out ports 14A and 14B have the same configuration as each other.

A banknote detection sensor similar to that of the pay-in port 13 is provided in the pay-out ports 14, whether or not there are one or more banknotes present inside the collection space is detected, and the detection result is transmitted to the controller 11.

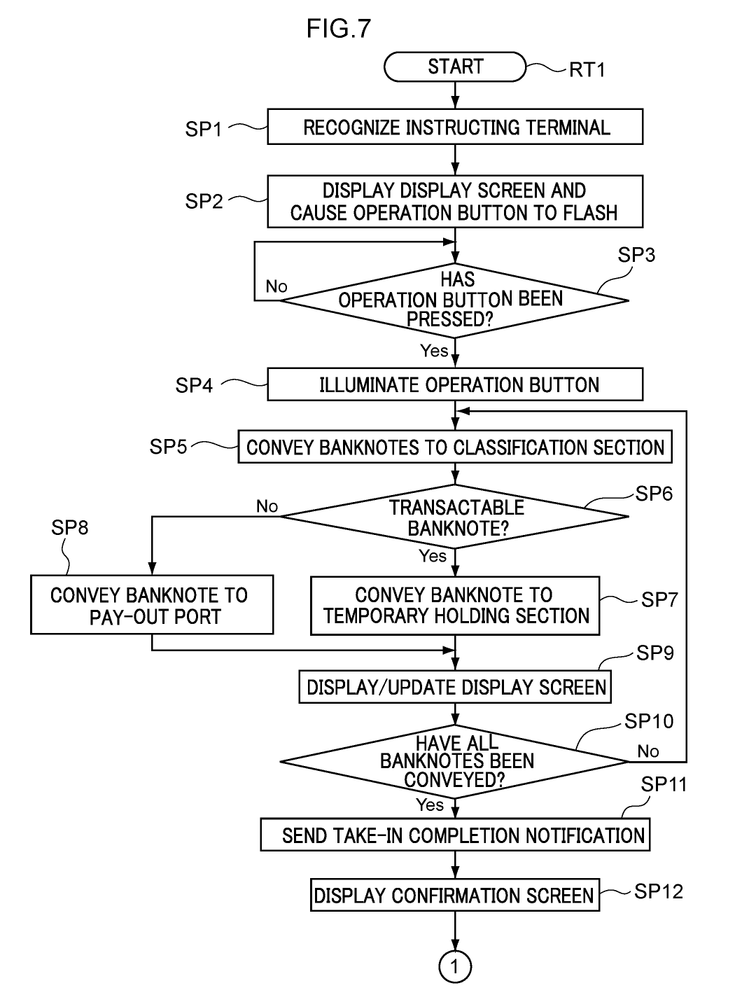

The collection spaces of the pay-out ports 14 each have a wide opening facing upwards, and are each provided with an opening and closing cover CV. As illustrated in FIG. 6, the covers CV restrict external access to inside the collection spaces (for example taking of banknotes) when closed, and permit external access to inside the collection spaces when open. Actuators and opening and closing mechanisms are incorporated in the covers CV such that the covers CV are opened or closed by the opening and closing mechanisms under control of the controller 11.

The covers CV basically close off the collection spaces when there are no banknotes collected inside the collection space, and during normal operation, such as when banknotes are being conveyed, and only allow temporary opening of the collection spaces for banknotes collected inside to be taken out.

The display operation section 15 is, for example, a liquid crystal display incorporating a touch sensor, called a touch panel, and displays specific operation menus, the state of progress and results of various processing etc. under control of the controller 11, thereby notifying various information to the operators M, and accepts input operations of the operators M and transmits the input operations to the controller 11.

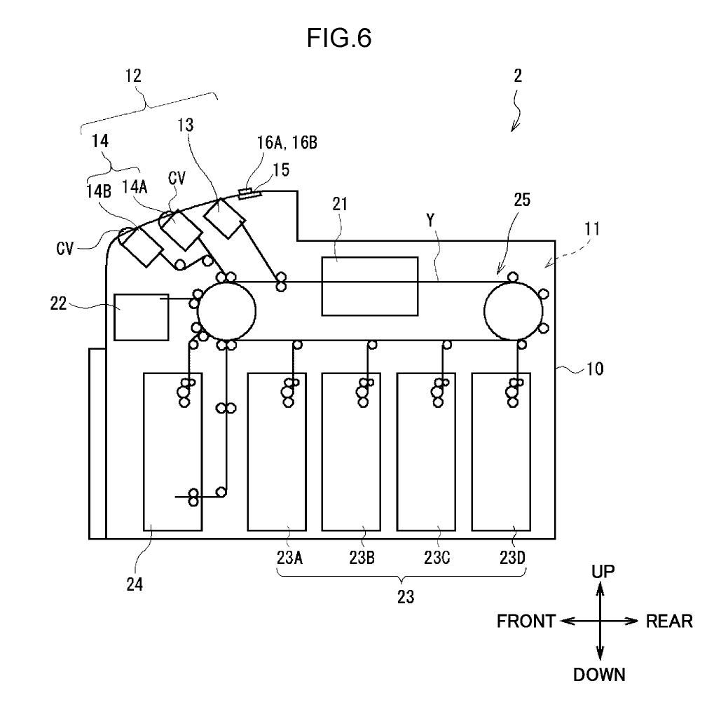

The liquid crystal display incorporated in the display operation section 15 is a dot matrix color liquid crystal display. The display operation section 15 is thereby able, as illustrated in FIG. 5, to make appropriate combinations of characters, graphics, symbols, and images, and moreover to display these with an appropriate hue on a display screen D, and to make appropriate changes to the display content.

The display screen D is configured, in broad terms, of a status box AR1 occupying a top end vicinity, an image box AR2 occupying a range from the center to the bottom side of the left half, and a text box AR3 of the remaining range.

Information expressing whether the banknote processing device 2 is being operated according to operation instructions from the terminal device 3A or 3B, namely information expressing which of the operators M positioned on the left or right of the banknote processing device 2 is in control, and information expressing the overall operation status of the banknote processing device 2, such as information expressing the state of progress of operations, are displayed in the status box AR1.

A pay-in/pay-out section image depicting the pay-in port 13 and the pay-out ports 14A and 14B of the pay-in/pay-out section 12 is disposed in the image box AR2. Long narrow frames FA and FB are displayed along the left-right direction in the image box AR2 and the text box AR3 so as to surround the pay-out ports 14A and 14B of the image box AR2, and to span across to the text box AR3 on the right side.

Information related to banknotes for conveying to the pay-out ports 14A and 14B, namely the denomination, number of notes, etc., is displayed in characters and numbers inside the frames FA and FB in the text box AR3. Information related to processing being executed (for example, pay-in processing and pay-out processing) is also displayed in characters and numbers inside the text box AR3 at the upper side of the frames FA and FB, and at the upper side of the pay-in/pay-out section image.

A help button BH appended with the symbol “?” is also displayed in the text box AR3. When the help button BH is operated by touch, a specific help screen is displayed on the display operation section 15 giving guidance, such as to the operation method.

The operation buttons 16A and 16B (FIG. 4) accept press operations by the operators M, and transmit the press operations to the controller 11. The operation buttons 16A and 16B (collectively referred to below as operation buttons 16) incorporate light emitting devices, such as light emitting diodes (LED), and, under control of the controller 11, the light emitting devices are caused to be illuminated or to flash, so as to obtain illumination or flashing of the operation buttons 16A and 16B overall.

This thereby enables, for example, notification that banknote pay-out processing is currently being executed for the operator MA on the left side of the banknote processing device 2 according to a pay-out instruction of the respective operator MA, by the operation button 16A disposed on the left side being illuminated or flashing.

When pressing of the operation button 16A is transmitted to the controller 11, the controller 11 is able to surmise that the pressing operation was performed by the operator MA on the left side due to the positional relationship to the display operation section 15.

Next, explanation follows regarding the internal configuration of the banknote processing device 2, with reference to FIG. 6. In addition to the controller 11 described above, a classification section 21, a temporary holding section 22, banknote cassettes 23A to 23D, a reject cassette 24, and a conveying section 25 are also provided inside the case 10 of the banknote processing device 2.

The classification section 21 is disposed to the rear of and below the pay-in port 13. The classification section 21 classifies banknotes conveyed in by the conveying section 25 according to whether or not they are transactable banknotes with which a transaction can be carried out based on denomination, authenticity, condition, running state, etc., and classifies as to whether or not they are re-useable banknotes capable of being reused based on their degree of damage, and transmits the classification results to the controller 11.

The temporary holding section 22 is disposed at the front of and below the pay-out ports 14, temporarily internally holds banknotes conveyed in by the conveying section 25, and sends the held banknotes one at time to the conveying section 25.

The reject cassette 24 is disposed furthest to the front side at a lower section inside the case 10, and, at the rear side of the reject cassette 24, banknote cassettes 23A, 23B, 23C, and 23D are disposed in a row in this sequence from the front toward the rear.

The banknote cassettes 23A to 23D internally store banknotes in a collected state, and each has an assigned denomination.

The banknote cassettes 23A to 23D internally store banknotes (normal banknotes) that have been conveyed in by the conveying section 25, stacked in the up-down direction, and feed the stored banknotes out one at a time and pass them across to the conveying section 25.

The reject cassette 24 internally collects and stores banknotes that have been classified as non-reusable by the classification section 21 (reject banknotes).

The conveying section 25 is configured by various rollers and belts disposed along a conveying path Y connecting each of the sections together inside the case 10, and by gears, a motor, etc. that drive the rollers, and belts. Conveying path switching mechanisms are disposed at branching point on the conveying path in the conveying section 25.

The conveying section 25 conveys banknotes along the conveying path under control of the controller 11, and switches the conveying destination of the banknotes using the conveying path switching mechanisms. FIG. 6 schematically illustrates only some of the components configuring the conveying section 25.

The banknote processing device 2 configured in this manner performs pay-in processing when a pay-in instruction is received from the terminal devices 3A and 3B (FIG. 1, FIG. 2). More specifically, the controller 11 of the banknote processing device 2 first allows the operators M to insert banknotes into the pay-in port 13 by performing a take-in operation, and then separates the banknotes one at a time and sends them in sequence to the conveying section 25. The conveying section 25 sends banknotes in sequence to the classification section 21 along the conveying path Y.

The controller 11 classifies each of the banknotes according to whether or not they are transactable banknotes using the classification section 21, and, while displaying a state of progress on the display operation section 15 based on the classification result (described in detail below), conveys transactable banknotes to the temporary holding section 22 using the conveying section 25, and conveys banknotes that cannot be transacted (reject banknotes) to the pay-out ports 14.

The controller 11 then, after having the operator M confirm the number of notes etc. of banknotes that have been classified, again conveys the transactable banknotes held in the temporary holding section 22 to the classification section 21 using the conveying section 25 such that the denomination and degree of damage are classified, while information such as the state of progress is displayed on the display operation section 15. When this is performed, the controller 11 stores the reusable banknotes in the banknote cassettes 23A to 23D according to denomination, and stores the unusable banknotes (reject banknotes) in the reject cassette 24.

The banknote processing device 2 performs pay-out processing when a pay-out instruction is received from the terminal devices 3A or 3B (FIG. 1 and FIG. 2). More specifically, controller 11 of the banknote processing device 2 first selects one out of the pay-out ports 14A and 14B as the selected pay-out port 14S.

The controller 11 then, while displaying information such as the state of progress on the display operation section 15 (described in detail below), feeds out in sequence, from the banknote cassettes 23A to 23D, banknotes of the denomination and number of notes corresponding to the pay-out amount, and then conveys these banknotes in sequence to the selected pay-out port 14S using the conveying section 25.

Then, when all of the banknotes have been conveyed to the selected pay-out port 14S, the controller 11 opens the respective cover CV, and allows the operator M to take the banknotes.

Thus, the banknote processing device 2 performs pay-in processing and pay-out processing, while appropriately displaying on the display operation section 15 of the pay-in/pay-out section 12 various information based on the classification result, the conveying state, and the like of the banknotes.

1.3 Processing Routine

Explanation next follows regarding the respective processing routines when the banknote processing device 2 executes pay-in processing and pay-out processing in the banknote pay-out system 1.

1-3-1. Pay-In Processing

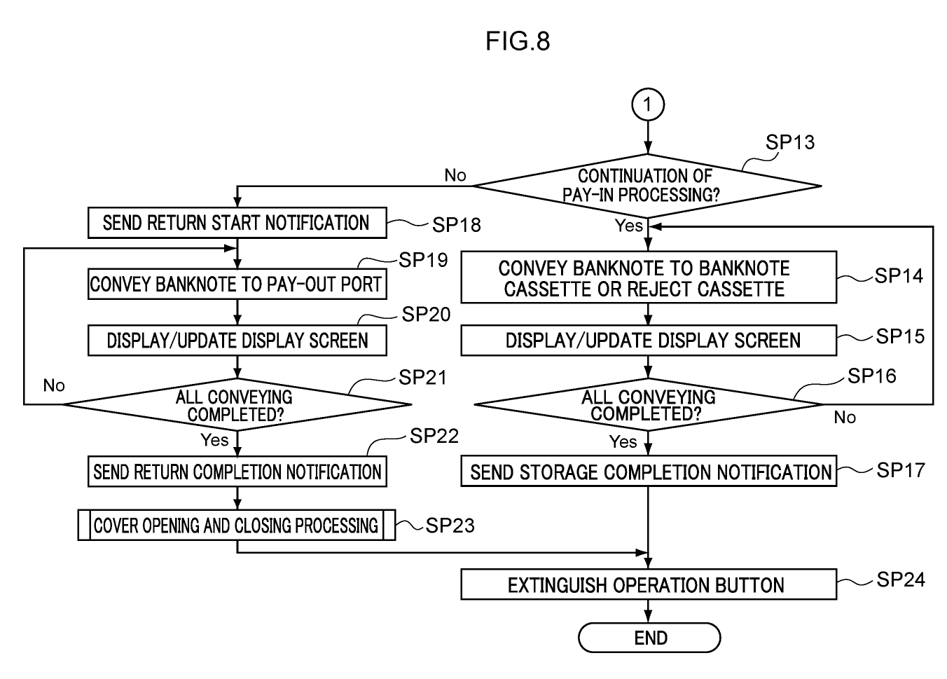

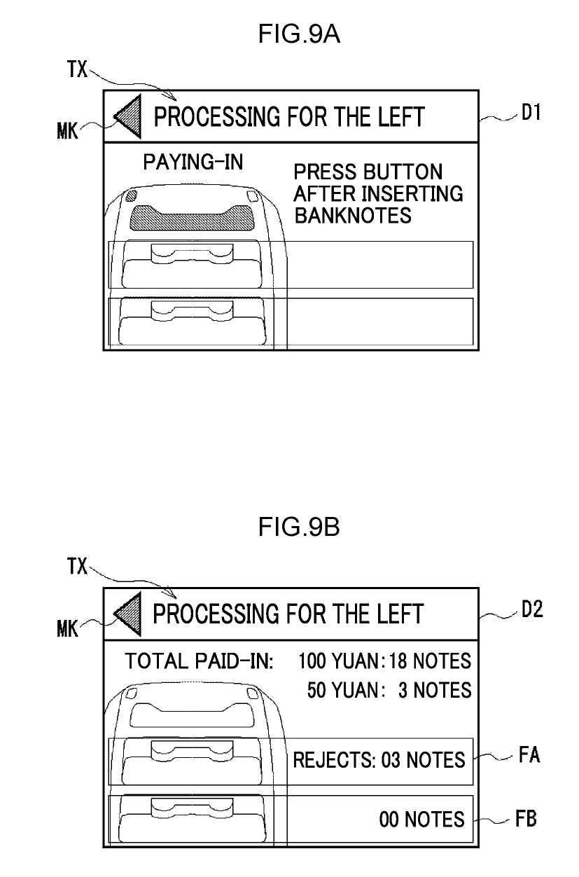

First, detailed explanation follows regarding the pay-in processing routine when the banknote processing device 2 performs pay-in processing, with reference to the flowcharts of FIG. 7 and FIG. 8.

For example, when the operators MA and MB (FIG. 2) receive an order for a pay-in procedure from a customer CS, and have received the banknotes, a pay-in instruction is sent to the banknote processing device 2 over the network 4 (FIG. 1) by operation by the terminal devices 3A and 3B. Explanation follows regarding a case in which the pay-in instruction is sent from the terminal device 3A operated by the operator MA on the left side.

The controller 11 of the banknote processing device 2 starts a pay-in processing routine RT1 (FIG. 7) when the pay-in instruction has been received from the terminal device 3 (in this case the terminal device 3A), and then transitions to step SP1.

At step SP1, the controller 11 recognizes the terminal device 3A that sent the pay-in instruction as an instructing terminal 3S, and then transitions to step SP2.

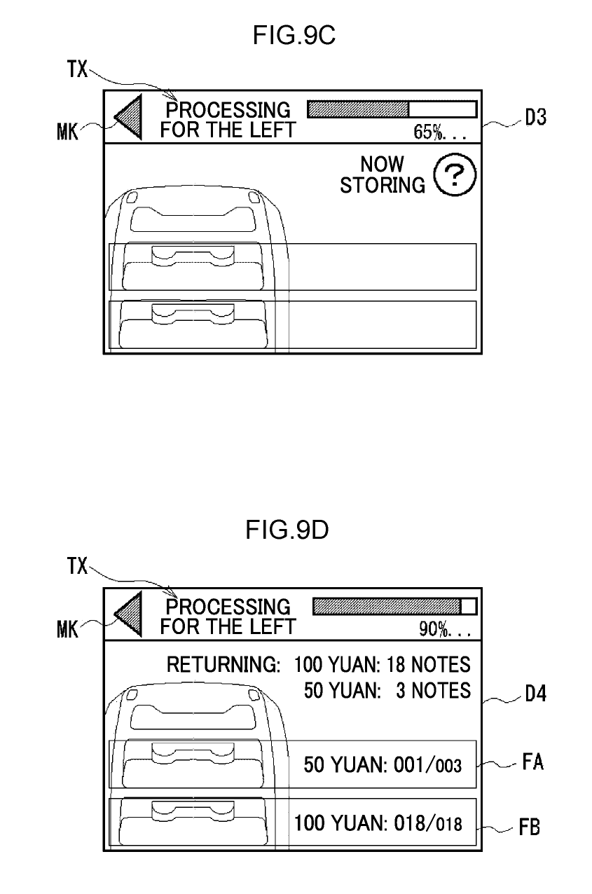

At step SP2, the controller 11 causes the operation button 16A that is the operation button 16 on the instructing terminal 3S side to flash, so as to indicate that insertion of banknotes by the operator M on the instructing terminal 3S side is awaited. Also, as illustrated in FIG. 9A, the controller 11 displays a display screen D1 prompting insertion of banknotes into the pay-in port 13 on the display operation section 15, and then transitions to step SP3.

A triangular directional mark MK facing toward the left is disposed at the left end of the status box AR1 of the display screen D1, and text TX of “Processing for the left” is disposed at the left side of the status box AR1.

The image box AR2 of the display screen D1 has the pay-in port 13 and the left side operation button 16A colored in different colors to other portions of the image depicting the pay-in/pay-out section 12. Text of “Paying-in” is displayed at the upper side portion of the text box AR3 of the display screen D1 to show details of the current operation status, and a message “Press button after inserting banknotes” is also displayed.

Through the display screen D1, the banknote processing device 2 is able to make the operator M aware that pay-in processing has started, aware that the pay-in processing is being performed according to the pay-in instruction from the terminal device 3A as the instructing terminal 3S, and aware of the task that the operator M should perform in order to proceed with the pay-in processing.

At step SP3, the controller 11 determines whether or not the operation button 16A that is the operation button 16 on the instructing terminal 3S side has been pressed. On obtaining a negative determination result, the controller 11 stands by for pressing of the operation button 16A by repeating step SP3.

However, on obtaining an affirmative result at step SP3, since this indicates that the operation button 16A that is the operation button 16 on the instructing terminal 3S side has been pressed, this can be surmised to indicate that the operation button 16A has been pressed after the operator M on the instructing terminal 3S side has inserted banknotes into the pay-in port 13. The controller 11 then transitions to the next step SP4.

At step SP4, the controller 11 changes the operation button 16 on the instructing terminal 3S side from flashing to illuminated, indicating that operation is being performed according to an operation instruction from the instructing terminal 3S, and then transitions to step SP5.

At step SP5, the controller 11 separates the banknotes that have been inserted into the pay-in port 13 one at a time, passes them across to the conveying section 25 to be conveyed to the classification section 21 for classification processing, and then transitions to step SP6.

At step SP6, the controller 11 determines whether or not the result of classification processing in the classification section 21 was that the banknote was a transactable banknote. When an affirmative result is obtained, this indicates that the banknote should be taken inside and stored, and the controller 11 transitions to the next step SP7.

At step SP7, the controller 11 conveys the banknotes classified as transactable banknotes to the temporary holding section 22 using the conveying section 25, and then transitions to step SP9. The controller 11 counts the banknotes that have been classified as transactable banknotes for each denomination, and stores the values.

When a negative determination result is obtained at step SP6, this indicates that the banknote should not be taken inside, and should be returned to the operators M, and the controller 11 transitions to the next step SP8.

At step SP8, the controller 11 conveys the banknotes classified as not being suitable for transaction (namely the reject banknotes) to one of the pay-out ports 14A or 14B (for example, pay-out port 14A), and then transitions to step SP8. The controller 11 counts the number of banknotes classified as not being suitable for transaction, and stores this value.

At step SP9, as illustrated in FIG. 9B, the controller 11 displays a display screen D2 on the display operation section 15 to display the current operation status of the banknote processing device 2, and then transitions to step SP10.

The status box AR1 of the display screen D2 is similar to that of the display screen D1, and indicates by the directional mark MK and the text TX that pay-in processing is being executed according to the pay-in instruction from the operator MA on the left side.

Text of “Total paid-in:” indicating details of the current operation status, and text of “100 yuan: 18 notes”, and “50 yuan: 3 notes” indicating the banknote classification result as the total number of notes for each denomination, is displayed at the upper side portion of the text box AR3 of the display screen D2.

Furthermore, text of “Rejects: 03 notes” and “00 notes” indicating the number of banknotes conveyed to the pay-out ports 14A and 14B that have been determined to be reject banknotes are respectively displayed at a lower side portion of the text box AR3 of the display screen D2, namely inside the frames FA and FB.

At step SP10, the controller 11 determines, based on a detection result acquired from the banknote detection sensor of the pay-in port 13, whether or not there are any banknotes remaining inside the pay-in port 13, namely whether or not all the inserted banknotes have been conveyed out. When a negative determination result is obtained, this indicates that remaining banknotes still need to be conveyed to the classification section 21, and so the controller 11 returns again to step SP5.

However, when an affirmative detection result is obtained at step SP10, this indicates that all the inserted banknotes have completed classification processing, and the denomination and number of banknotes are final, and the controller 11 transitions to the next step SP11.

At step SP11, the controller 11 transmits to the instructing terminal 3S a take-in completion notification that is information notifying that operation to take in banknotes from the pay-in port 13 has been completed, and then transitions to step SP12.

When this take-in completion notification is received, the instructing terminal 3S displays a specific message window on a display screen. The message window displays, for example, a message (text) indicating that take-in has been completed, and the number of notes taken in for each of the denominations of banknotes, and, when there are reject banknotes, displays the number of notes and the pay-out port to which they have been conveyed, as information representing the operation status of the banknote processing device 2.

At step SP12, the controller 11 displays a specific confirmation screen on the display operation section 15 so as to have the operator M perform operational input to indicate whether or not to continue pay-in processing after the number of notes has been displayed for each of the denominations, then transitions to step SP13 (FIG. 8).

When the banknotes classified as not being suitable for transaction (reject banknotes) have been conveyed to the pay-out port 14A or 14B, the controller 11 temporarily opens the cover CV of each of the pay-out ports 14 by performing a combination of cover opening and closing processing, described below, and allows the operator M to take the banknotes that have been collected inside.

At step SP13, the controller 11 determines whether or not there has been an operational input by the operator M to indicate continuation of pay-in processing. When an affirmative detection result is obtained here, the banknotes that have been conveyed to the temporary holding section 22 are now to be conveyed to a banknote cassette 23 or to the reject cassette 24, and so the controller 11 transitions to the next step SP14.

At step SP14, the controller 11 separates the banknotes being held in the temporary holding section 22 one note at a time and again conveys them to the classification section 21 such that each banknote is classified according to denomination, degree of damage, and the like, and after conveying according to the detection result, transitions to the next step SP15.

At this time the controller 11 conveys banknotes that have a small degree of damage and have been classified as reusable banknotes to the banknote cassettes 23A to 23D for storage according to the respective denomination using the conveying section 25. The controller 11 also conveys reject banknotes that have been classified as banknotes not suitable for reuse having a high degree of damage to the reject cassette 24 for storage using the conveying section 25.

As illustrated in FIG. 9C, at step SP15, the controller 11 displays a display screen D3 indicating the current operation status of the banknote processing device 2 on the display operation section 15, and then transitions to step SP16.

A directional mark MK and text TX similar to those of the display screen D1 are disposed at the left half of the status box AR1 of the display screen D3, indicating that pay-in processing is being executed according to a pay-in instruction from the operator MA on the left side. Text of “Now storing” is displayed at the upper side portion of the text box AR3 of the display screen D3 to indicate details of the current operation status.

Moreover, a long thin rectangular shaped progress bar and a number expressing the percentage of progress is displayed along the left-right direction at the right half of the status box AR1 of the display screen D3. The progress bar is only colored over a specific range starting from the left end, and visually represents the degree of progress by the proportion of the whole occupied by the colored range. The “degree of progress” referred to here is expressed by the proportion of banknotes that have finished being stored in the banknote cassettes 23A to 23D or the reject cassette 24 from out of the total banknotes being held in the temporary holding section 22.

At step SP16, the controller 11 determines whether or not all the banknotes that were remaining in the temporary holding section 22 have finished being conveyed to the banknote cassettes 23A to 23D or the reject cassette 24. A negative determination result obtained here indicates that there are still banknotes remaining in the temporary holding section 22, and so the controller 11 returns again to step SP14 in order to convey these banknotes to the banknote cassettes 23A to 23D or the reject cassette 24.

However, an affirmative detection result obtained at step SP16 indicates that the entire processing of the pay-in processing has been completed by conveying all the transactable banknotes from the temporary holding section 22 to the banknote cassettes 23A to 23D or to the reject cassette 24 for storage, and so the controller 11 transitions to the next step SP17.

At step SP17, the controller 11 transmits a storage completion notification that is information notifying that the banknote storage operation has been completed to the instructing terminal 3S, and then transitions to step SP24.

The instructing terminal 3S displays a specific message window on a display screen when this storage completion notification is received. For example, a message (text) indicating that banknote storage has been completed, the number of notes stored in the banknote cassettes 23A to 23D for each of the denominations, and the denomination and number of notes of the banknotes that have been stored in the reject cassette 24, are displayed in the message window as information indicating the operation status in the banknote processing device 2.

However, when a negative determination result is obtained at step SP13, this indicates that the operator M wants to halt the pay-in processing, and so the controller 11 transitions to the next step SP18 in order to perform a return operation to return all the banknotes being held in the temporary holding section 22 to the operator M.

At step SP18, after assigning respective denominations to the pay-out ports 14A and 14B, the controller 11 sends the instructing terminal 3S a return start notification that is information notifying the start of a return operation of banknotes, and then transitions to step SP19.

The instructing terminal 3S displays a specific message window on a display screen when the return start notification is received. For example, a message (text) indicating the start of returning banknotes, and the denomination and number of notes of banknotes that are scheduled to be conveyed to each of the pay-out ports 14 is displayed in the message window as information indicating the operation status in the banknote processing device 2.

At step SP19, the controller 11 uses the conveying section 25 to sequentially convey banknotes in the temporary holding section 22 to the pay-out port 14A or 14B, while sorting by denomination, and then transitions to step SP20.

As illustrated in FIG. 9D, at step SP20 the controller 11 displays a display screen D4 indicating the current operation status of the banknote processing device 2 on the display operation section 15, and then transitions to step SP21.

A directional mark MK and text TX similar to that of the display screens D1 to D3 is disposed at the left half of the status box AR1 of the display screen D4, indicating that pay-in processing is being executed according to a pay-in instruction from the operator MA on the left side.

A progress bar and a number expressing the degree of progress, similar to those on the right half of the status box AR1 of the display screen D3 (FIG. 9), are displayed on the right half of the status box AR1 of the display screen D4.

Text of “Returning” indicating details of the current operation status, and text of “100 yuan: 18 notes” and “50 yuan: 3 notes” indicating the number of notes for each denomination of the banknotes to be returned, are displayed in an upper side portion of the text box AR3 of the display screen D4.

Text of “50 yuan: 001/003” and “100 yuan: 018/018” are respectively displayed in the lower side portion of the text box AR3 of the display screen D4, namely inside the frames FA and FB, to indicate the denomination and number of banknotes actually conveyed to the pay-out ports 14A and 14B together with the total number of notes to be returned.

At step SP21, the controller 11 determines whether or not all the banknotes that were remaining in the temporary holding section 22 have finished being conveyed to the pay-out ports 14A or 14B. In cases in which a negative determination result is obtained here, there are banknotes remaining in the temporary holding section 22, and so the controller 11 returns again to step SP19 in order to convey these banknotes to the pay-out port 14A or 14B.

However, in cases in which an affirmative detection result is obtained at step SP21, all the transactable banknotes have been conveyed out from the temporary holding section 22 to the pay-out port 14A or 14B, and so the controller 11 then transitions to the next step SP22.

At step SP22, the controller 11 sends a return completion notification that is information to notify that the banknote return operation has been completed to the instructing terminal 3S, and then transitions to the next step SP23.

When the return completion notification is received, the instructing terminal 3S displays a specific message window on the display screen. For example, a message (text) indicating that banknote return has been completed, and the denomination and number of notes of the banknote that have been conveyed for each of the pay-out ports 14 are displayed in this message window, as information indicating the operational status in the banknote processing device 2.

At step SP23, the controller 11 temporarily opens the covers CV of the pay-out ports 14A and 14B by executing cover opening and closing processing, described below, and allows the operator M to take out the banknotes, then transitions to the next step SP24.

At step SP24, the controller 11 extinguishes the operation button 16 on the instructing terminal 3S side, and then, after indicating that operation has completed according to the operation instruction from the instructing terminal 3S and standby has been entered, transitions to the next step and ends the pay-in processing routine RT1.

1-3-2. Pay-Out Processing

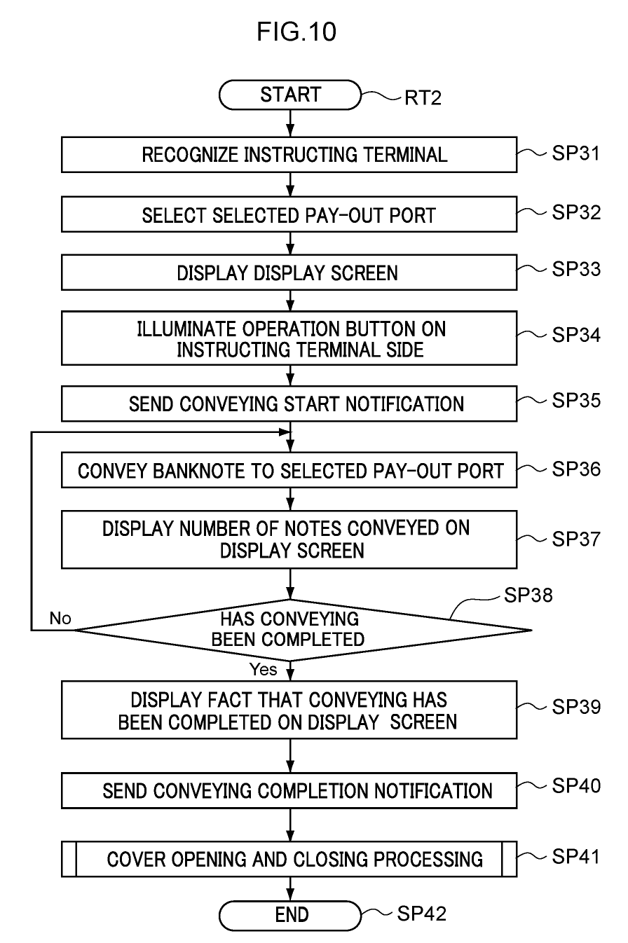

Explanation next follows regarding details of a pay-out processing routine when the banknote processing device 2 in the banknote pay-out system 1 performs pay-out processing, with reference to the flowchart in FIG. 10.

For example, when the operators MA and MB (FIG. 2) receive an order for a pay-out procedure from a customer CS, a pay-out instruction is sent over the network 4 (FIG. 1) to the banknote processing device 2 by operating the terminal devices 3A and 3B. Explanation follows regarding an example of a case in which the pay-out instruction was sent by the terminal device 3B operated by the operator MB.

When the pay-out instruction is received from the terminal device 3 (in this case the terminal device 3B), the controller 11 of the banknote processing device 2 starts a pay-out processing routine RT2 then transitions to step SP31.

At step SP31, the controller 11 recognizes the terminal device 3B that sent the pay-out instruction as the instructing terminal 3S, and then transitions to the next step SP32.

At step SP32, the controller 11 selects one or other, or both, of the pay-out ports 14A and 14B, sets the selected port(s) as a selected pay-out port 14S that is the pay-out ports 14 for paying out the banknotes in the pay-out processing, then transitions to the next step SP3.

Consider a case here, for example, in which banknotes paid out immediately before by pay-out instruction from the operator MA are still left untaken from the pay-out port 14B, then the unused pay-out port 14A is selected as the selected pay-out port 14S.

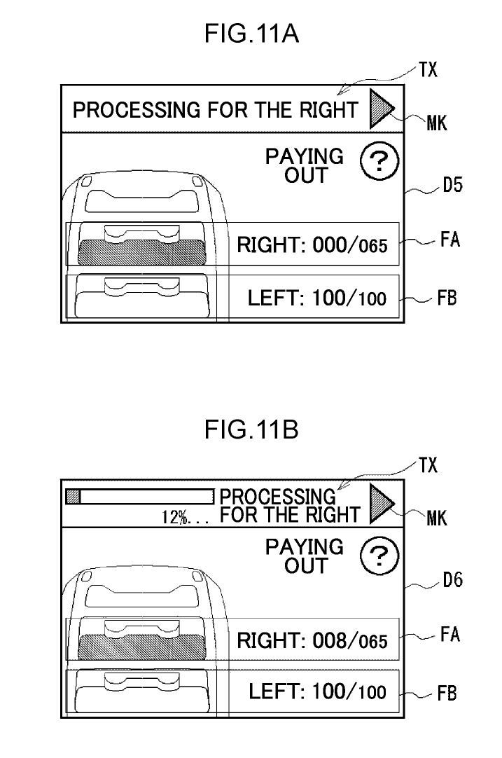

At step SP33, the controller 11 displays on the display operation section 15 a display screen D5 indicating the operational status of pay-out processing as illustrated in FIG. 11A, then transitions to the next step SP34.

A triangular shaped directional mark MK facing toward the right is disposed on the right end of the right half of the status box AR1 of the display screen D5, with text TX of “Processing for the right” disposed on the left side thereof, thereby indicating that pay-out processing is being executed according to a pay-out processing instruction from the operator MB on the right side.

In the image box AR2 of the display screen D5, the portion of the pay-out port 14A in the image depicting the pay-in/pay-out section 12 is applied with a different color to other portions. Text of “Paying out” indicating the details of the current operation status is displayed in an upper side portion of the text box AR3 of the display screen D5.

By employing the display screen D5, the banknote processing device 2 is able to make the operator M aware that pay-out processing has been started, that this pay-out processing is based on a pay-out processing instruction from the terminal device 3B that is the instructing terminal 3S, and that the conveying destination of the banknotes is the pay-out port 14A that is the selected pay-out port 14S.

At step SP34, the controller 11 illuminates the operation button 16B that is the operation button 16 of the instructing terminal 3S side, then transitions to the next step SP35. At step SP35, the controller 11 transmit a conveying start notification that is information notifying that conveying processing has started to the instructing terminal 3S, then transitions to the next step SP36.

The conveying start notification here includes information indicating that the selected pay-out port 14S is the pay-out port 14A etc., in addition to information indicating that the banknote conveying processing has started.

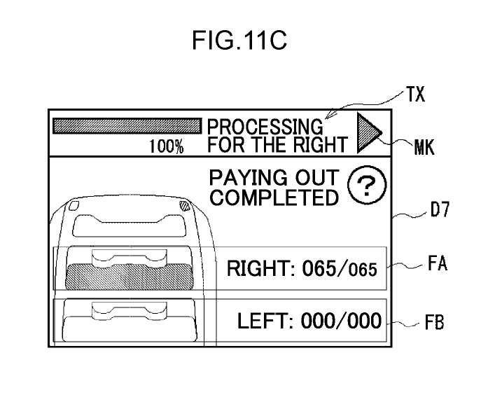

When this conveying start notification is received, the instructing terminal 3S displays a message window W1 on a display screen, for example as illustrated in FIG. 12A. For example, text such as “Banknote conveying processing has started” is displayed in the message window W1 as information indicating the operational status in the banknote processing device 2.

For example, an image illustrating the pay-in/pay-out section 12 on the left side is disposed in the message window W1 as information indicating the selected pay-out port 14S, the portion displaying the pay-out port 14A is applied with a different display color to other portions, and also text such as “Banknotes are being paid out to the first pay-out port” is displayed. The “first pay-out port” indicates, for example, the pay-out port 14A on the far side, and the operators M are made aware of this in advance.

At step SP36, the controller 11 feeds out the denomination and number of banknotes specified by the pay-out instruction from the banknote cassette 23, and conveys these to the selected pay-out port 14S using the conveying section 25, then transitions to the next step SP37.

As illustrated in FIG. 11B, at step SP37, the controller 11 displays the display screen D6, on which the operational status of the banknote processing device 2 is displayed, on the display operation section 15, and then transitions to the next step SP38.

A directional mark MK and text TX similar to that of the display screen D5 is disposed at the right half of the status box AR1 of the display screen D6, thereby indicating that pay-out processing is being executed according to a pay-out instruction from the operator MB on the right side. Text of “Paying out” expressing details of the current operation status is displayed in an upper side portion of the text box AR3 of the display screen D6.

Moreover, a progress bar and a number expressing the degree of progress as a percentage similar to those on the right half of the status box AR1 of the display screen D3 (FIG. 9) is displayed on the left half of the status box AR1 of the display screen D6. In this case the “degree of progress” indicates the proportion of banknotes that have completed conveying to the pay-out port 14A that is the selected pay-out port 14S from out of all the banknotes that should be paid out in the pay-out processing.

Moreover, text of “Right” indicating that conveying is being performed based on the pay-out instruction from the operator MB on the right side for the banknotes that have been conveyed to the pay-out port 14A that is the selected pay-out port 14S, and text (numbers) of “008/065” indicating the number of notes that have completed conveying and the total number of notes scheduled to be conveyed, are each displayed inside the frame FA in the text box AR3 of the display screen D6.

Text of “Left” indicating that conveying was performed based on the pay-out instruction from the operator MA on the left side for the banknotes that have been conveyed to the pay-out port 14B that was the selected pay-out port 14S in the immediately preceding pay-out processing, and text (numbers) of “100/100” indicating the number of notes that have completed conveying and the total number of notes scheduled to be conveyed, are each displayed inside the frame FB in the text box AR3 of the display screen D6.

At step SP38, the controller 11 determines whether or not conveying of all the banknotes to the selected pay-out port 14S has finished according to the pay-out instruction. A negative determination result obtained here indicates that the banknote conveying processing should be continued, and so in such cases the controller 11 then returns again to step SP36.

An affirmative detection result obtained at step SP38 indicates that the banknotes collected inside the collection space should be taken by the operator M. In such cases the controller 11 then transitions to the next step SP39.

As illustrated in FIG. 11C, at step SP39, the controller 11 displays a display screen D7 indicating the operational status of the banknote processing device 2 on the display operation section 15, and then transitions to the next step SP40.

A directional mark MK and text TX similar to that of the display screen D5 are disposed at the right half of the status box AR1 of the display screen D7, thereby indicating that pay-out processing is being executed according to a pay-out instruction from the operator MB on the right side. Text of “Pay-out complete” expressing details of the current operation status is displayed in an upper side portion of the text box AR3 of the display screen D7.

Moreover, a progress bar and a number expressing the degree of progress as a percentage, similar to those of the display screen D6, are displayed on the left half of the status box AR1 of the display screen D7. On completing conveying of the banknotes to the selected pay-out port 14S, the entire region of the progress bar is colored, and the number indicating the percentage of “100%” is displayed on the display screen D7.

At step SP40, the controller 11 transmits the terminal device 3B that is the instructing terminal 3S a conveying completion notification that is information notifying that banknote conveying to the pay-out port 14A that is the selected pay-out port 14S has been completed, then transitions to the next step SP41.

When this conveying completion notification is received, the instructing terminal 3S displays a message window W2 on the display screen, for example, as illustrated in FIG. 12B. Information indicating the operational status of the banknote processing device 2 and information indicating the selected pay-out port 14S, for example text such as “Banknotes have been conveyed to the first pay-out port. Please press the operation button, open the cover, and take the banknotes”, is displayed in the message window W2. Similarly to in the message window W1, an image showing the pay-in/pay-out section 12 is disposed in the left side portion inside the message window W2, with the portion showing the pay-out port 14A applied with a different display color to other portions.

At step SP41, the controller 11 temporarily opens the covers CV of the pay-out port 14A that is the selected pay-out port 14S by executing cover opening and closing processing, described below, and after allowing the operator MB to take out the banknotes, then transitions to the next step SP42, and ends the pay-out processing routine RT2.

1-3-3 Cover Opening and Closing Processing

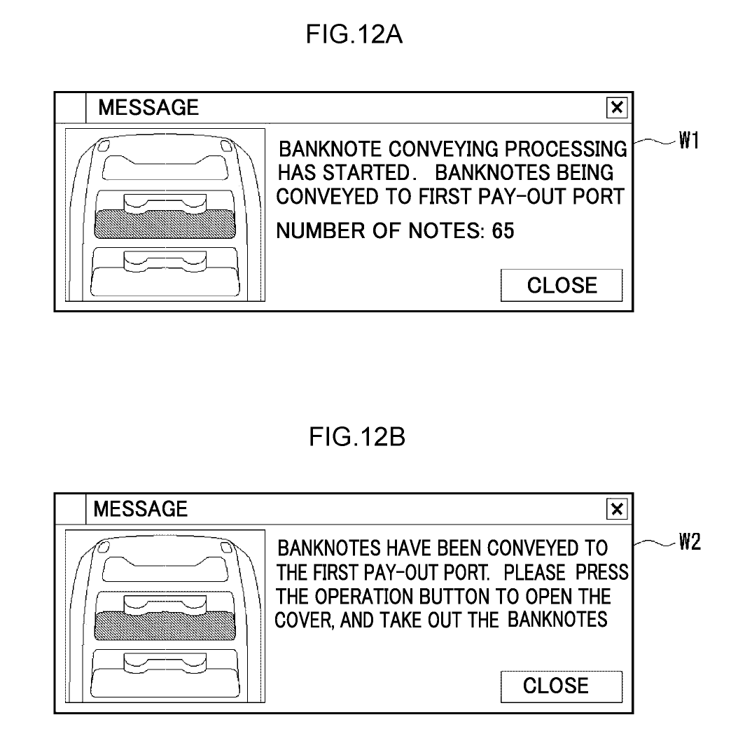

Explanation next follows regarding a cover opening and closing processing routine executed as a subroutine when the banknote processing device 2 performs pay-in processing and pay-out processing in the banknote pay-out system 1, with reference to the flowchart in FIG. 13.

Explanation follows regarding an example of a case in which the banknote processing device 2 executes pay-out processing according to a pay-out instruction from the terminal device 3B on the right side that is the instructing terminal 3S, with the pay-out port 14A serving as the selected pay-out port 14S.

The controller 11 of the banknote processing device 2 transitions to step SP41 in a state in which conveying of banknotes to the selected pay-out port 14S has finished in the pay-out processing routine RT2 (FIG. 10), starts the cover opening and closing processing routine SRT3, and transitions to step SP51.

At step SP51, the controller 11 causes the operation button 16B to flash by periodically illuminating and extinguishing the light emitting devices installed in the operation button 16B that is the operation button 16 on the instructing terminal 3S side, then transitions to the next step SP52.

At step SP52, the controller 11 determines whether or not the operation button 16 that is the operation button 16 on the instructing terminal 3S side has been pressed. When a negative determination result is obtained here, this indicates that the operator M is not yet ready to take out the banknotes from the selected pay-out port 14S. In such cases the controller 11 repeats step SP52, and stands by until the operation button 16B is pressed.

The controller 11 strictly discriminates at step SP52 between the operation button 16B that is on the instructing terminal 3S side and the operation button 16A on the opposite side, and, even if the operation button 16A on the opposite side to the instructing terminal 3S was to be pressed, would ignore the pressing, and would repeat step SP52 until the operation button 16B on the instructing terminal 3S side has been pressed.

When an affirmative detection result is obtained at step SP52, this indicates that the operator MB on the instructing terminal 3S side has recognized that conveying of banknotes to the selected pay-out port 14S has been completed, and the operator MB is ready to take the banknotes from the selected pay-out port 14S. In such cases the controller 11 transitions to the next step SP53.

At step SP53, the controller 11 indicates receipt of the press operation of the operation button 16B by the operator MB on the instructing terminal 3S side by illuminating the operation button 16B that is the operation button 16 on the instructing terminal 3S side, and then transitions to the next step SP54.

At step SP54, the controller 11 externally exposes the collection space by driving the cover CV of the pay-out port 14A that is the selected pay-out port 14S to switch from a closed state to an open state, and then transitions to the next step SP55.

At step SP55, the controller 11 determines whether or not the banknotes have been taken from the selected pay-out port 14S according to banknote detection results of the banknote detection sensor incorporated into the pay-out port 14A that is the selected pay-out port 14S. When a negative determination result is obtained here, the controller 11 stands by for the banknotes to be taken from the selected pay-out port 14S by repeating step SP55.

When an affirmative detection result is obtained at step SP55, the controller 11 transitions to step SP56. At step SP56, the controller 11 returns the display color of the portion of the selected pay-out port 14S (the pay-out port 14A) in the image of the image box AR2 to the normal display color, and then returns to the next step S57.

At step SP57, the controller 11 extinguishes the operation button 16B that was illuminated at step SP53 and that is the operation button 16 on the instructing terminal 3S side, and then transitions to the next step SP58.

At step SP58, the controller 11 closes off the collection space to the outside by driving the cover CV of the pay-out port 14A that is the selected pay-out port 14S to switch from the open state to the closed state, and then transitions to the next step SP59.

At step SP59, the controller 11 completes one series of processing accompanying the opening and closing of the cover CV on the selected pay-out port 14S by ending the cover opening and closing processing routine SRT3, and transitions to step SP41 of the original pay-out processing routine RT2 (FIG. 10).

1-4. Operation and Advantageous Effects

In the above configuration, the banknote processing device 2 of the banknote pay-out system 1 of the first exemplary embodiment is provided with the pay-out ports 14A and 14B at two locations of the pay-in/pay-out section 12.

When the banknote processing device 2 receives a pay-out instruction from one of the terminal devices 3, the banknote processing device 2 displays the display screen D5 (FIG. 11A) on the display operation section 15 after selecting one of the pay-out port 14A or 14B as the selected pay-out port 14S.

The banknote processing device 2 is accordingly able to make the operator M that instructed paying out of banknotes through the instructing terminal 3S aware as to which of the pay-out ports 14A or 14B is the selected pay-out port 14S banknotes will then be conveyed to.

When this is performed, the banknote processing device 2 enables intuitive awareness of the position of the pay-out port 14A in the pay-in/pay-out section 12 by coloring the selected pay-out port 14S (the pay-out port 14A) in the image depicting the pay-in/pay-out section 12 in the image box AR2 of the display screen D5.

Moreover, when this is performed, the banknote processing device 2 is able to make it easily understood from which of the operators M the pay-out instruction was received by displaying on the display screen D5 (FIG. 11A) the triangular shaped directional mark MK indicating the operator M (MA or MB) who performed a pay-out operation through the terminal device 3, and the text TX such as “Processing for the right”.

Furthermore, when this is performed, the banknote processing device 2 displays text of “Left” or “Right” indicating the operator M who performed the pay-out operation, and a numerical value indicating the number of notes scheduled to be conveyed, on the display screen D5 (FIG. 11A) and inside the frame FA that indicates that the pay-out port 14A is the selected pay-out port 14S.

The banknote processing device 2 is thereby able to make it clearly understandable to the operator M looking at the display screen D5 who out of the operator MA on the left side or the operator MB on the right side issued the instruction under which the banknotes were conveyed to the pay-out port 14A that is the selected pay-out port 14S, and the number of the notes. When this is performed, the banknote processing device 2 can enable the operator M to predict an approximate time required until banknote conveying is complete by displaying the number of notes.

Moreover, even when the banknotes that have been conveyed to one of the pay-out ports 14 by the immediately preceding pay-out processing have not yet been taken by the operator M, the banknote processing device 2 still conveys banknotes to the other pay-out port 14 selected as the new selected pay-out port 14S.

The banknote processing device 2 accordingly does not need to wait until the operator M has taken the banknotes conveyed by the immediately preceding pay-out, enabling the time required for pay-out processing to be suppressed to a minimum.

When this is performed, the banknote processing device 2 displays text of “Left” or “Right” indicating the operator M who performed the immediately preceding pay-out operation, and a numerical value indicating the number of notes conveyed, inside the frame FB showing the pay-out port 14B on the display screen D5.

Thus the banknote processing device 2, by using text indicating the operator M and the respective number of notes and states of progress, is accordingly able to clearly indicate the operator M who issued the instruction under which banknotes have been conveyed to each of the respective pay-out ports 14 and that banknotes are in the process of being conveyed to each of the respective pay-out ports 14, enabling mistaken taking of banknotes by the operators M to be prevented before it occurs.

In addition, the banknote processing device 2 is able to make the operators M quickly aware of which of the operators M issued the operation instruction under which banknotes are currently being conveyed by illuminating the operation button 16 on the instructing terminal 3S side, without making the operators M read detailed characters, marks, or the like displayed on the display operation section 15.

Namely, in the banknote processing device 2, due to the operation button 16A being disposed toward the left end of the pay-in/pay-out section 12, and the operation button 16B being disposed toward the right end of the pay-in/pay-out section 12, the operation button 16A on the left side is easily understood as being for the operator MA on the left side, and the operation button 16A on the right side is easily understood as being for the operator MB on the right side.

Moreover, the banknote processing device 2 transmits the conveying start notification to the instructing terminal 3S, and displays the conveying start notification on the display screen in the message window W1 (FIG. 12A). The banknote processing device 2 is thereby able to rapidly notify the operator M who normally has more chances to see the display screen of the instructing terminal 3S while performing operation that processing to convey the banknotes has started, and which out of the pay-out port 14A or the pay-out port 14B is the selected pay-out port 14S.

Then, when the banknote processing device 2 has started to convey the banknotes to the selected pay-out port 14S, the display screen D6 (FIG. 11B) is displayed on the display operation section 15 and successively updated, and displays the progress bar and the progress percent according to the state of progress, and displays the number of notes that have completed conveying. The banknote processing device 2 is thereby able to make the operator M aware of the state of progress of pay-out processing in detail, and also able to allow the operator M to anticipate the approximate time until conveying completion.

The banknote processing device 2 also switches the operation button 16 on the instructing terminal 3S side from illuminated to flashing when conveying of the banknote to the selected pay-out port 14S has been completed. The banknote processing device 2 is thereby able to notify by the flashing that banknote conveying processing has been completed and a state has been achieved in which the banknotes can be taken, and is also able to make the operator M (the MA or the MB) aware of which operator issued the pay-out instruction under which conveying processing is based by the position of each of the operation button 16 on the pay-in/pay-out section 12.

When this is performed, the banknote processing device 2 enables detailed intuitive awareness of what operation should be performed to the pay-in/pay-out section 12 by making the operation button 16 that should be press operated itself flash.

Moreover, since the cover CV of the selected pay-out port 14S is not opened and remains closed even if the operation button 16 on the opposite side of the instruction terminal is pressed, the banknote processing device 2 is able to eliminate the concern of banknotes being mistakenly taken out from the selected pay-out port 14S by the operator M who did not perform the pay-out operation.

Moreover, for example, a case can be anticipated in which the operators MA and MB transmit pay-out instructions from their respective terminal devices 3, and after conveying processing of banknotes has been completed to one of the pay-out ports 14, conveying processing is then completed to the other pay-out port 14 before the first banknotes have been taken.

In such cases, when one of the operation buttons 16 is pressed, since the banknote processing device 2 only opens the cover CV of the pay-out port 14 to which banknotes have been conveyed based on the pay-out instruction from the operator M on the same side of the banknote processing device 2 as the operation button 16, the banknote processing device 2 is able to make the operator M take the correct banknotes based on the pay-out instruction.

Moreover, in the banknote processing device 2, the display screen D7 (FIG. 11C) is displayed on the display operation section 15 when conveying of banknotes to the selected pay-out port 14S is complete. When this is performed, the banknote processing device 2 is able to make the operator M aware that pay-out processing has been completed by displaying text reading “pay-out complete”, as well as the progress bar and the progress percent.

Moreover, the banknote processing device 2 enables clear awareness as to which operator M a pay-out instruction is based on “Left” or “Right” as characters inside the frame FA displayed on the display screen D7 so as to correspond to the pay-out port 14A that is the selected pay-out port 14S, and clear awareness of the number of notes by the numbers displayed in the frame FA.

Together with this, the banknote processing device 2 transmits the conveying completion notification to the instructing terminal 3S, and displays the conveying completion notification on the display screen in the message window W2 (FIG. 12B). The banknote processing device 2 is thereby capable of notifying completion of banknote conveying processing and notifying which of the pay-out port 14A or 14B is the selected pay-out port 14S even when, for example, after starting conveying processing, the operator M performs another operation while looking at the display screen of the instructing terminal 3S.

When the banknote processing device 2 receives a pay-out instruction from one of the terminal devices 3 during pay-in processing, the display screen D1 (FIG. 9A) is displayed on the display operation section 15.

When this is performed, similarly to in pay-out processing, by displaying the triangular directional mark MK indicating which operator M (the MA or the MB) performed pay-in operation via the terminal device 3, and displaying the text TX such as “Processing for the left”, the banknote processing device 2 is able to make it easily understood from which operator M the pay-in instruction has been received.

Moreover, in cases in which a return operation is to be performed based on an operation of the operator M during pay-in processing, the banknote processing device 2 allocates banknotes to the pay-out ports 14A and 14B by denomination, and banknotes are conveyed while displaying the display screen D4 (FIG. 9D) on the display operation section 15.

The banknote processing device 2 is thereby able to make the operator M clearly aware of the denomination and number of notes of the banknotes to be conveyed to each of the pay-out ports 14, and also clearly aware of the state of progress.

When this is performed, the banknote processing device 2 is able to sort and convey the banknotes to the pay-out ports 14A and 14B by denomination, such that the operator M is not required to perform any further sorting of the banknotes either manually or using another device.

Moreover, when this is performed, the display screen D4 is displayed on the display operation section 15, and so the banknote processing device 2 enables correct awareness of the respective denominations and numbers of notes for the banknotes that have been conveyed to each of the pay-out ports 14.

According to the above configuration, the banknote processing device 2 of the banknote pay-out system 1 is provided with the pay-out ports 14A and 14B at two locations on the pay-in/pay-out section 12. The banknote processing device 2 is configured to indicate the correspondence between the operator M who instructed the processing being executed and the selected pay-out port 14S to which the banknotes are conveyed, and to indicate the state of progress, by using the illumination state of the operation buttons 16 and the display screen D displayed on the display operation section 15. Thus when performing new pay-out processing, even when the banknotes conveyed by the immediately previous pay-out processing remain in one of the pay-out ports 14, the banknote processing device 2 is able to convey banknotes to the other pay-out port 14 as the new selected pay-out port 14S without needing to wait until the first banknotes have been taken, and is able to preemptively prevent mistaken removal by the operator M in such circumstances.

### 2. Second Exemplary Embodiment

A banknote pay-out system 101 of a second exemplary embodiment differs from the banknote pay-out system 1 (FIG. 1) according to the first exemplary embodiment in including a banknote processing device 102 instead of the banknote processing device 2 (FIG. 3), however, other parts are configured similarly.

2.1 Banknote Processing Device Configuration

The banknote processing device 102 differs from the banknote processing device 2 according to the first exemplary embodiment in including a controller 111 and a pay-in/pay-out section 112 instead of the controller 11 and the pay-in/pay-out section 12, however, other parts are configured similarly.

The controller 111, similarly to the controller 11 of the first exemplary embodiment, is configured around a CPU, and performs unified overall control, and various processing such as pay-in processing and pay-out processing by reading a specific program from ROM, flash memory, or the like, and executing the program.

However, the controller 111 executes pay-in processing and pay-out processing according to a processing routine that partly differs from that of the first exemplary embodiment (details given below).

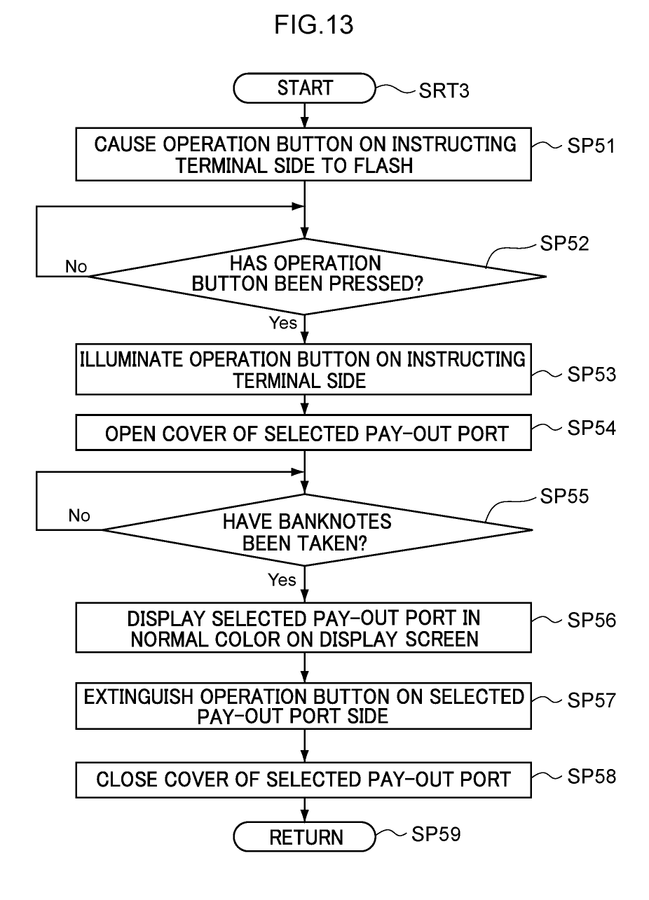

As illustrated in FIG. 14 corresponding to FIG. 4, the pay-in/pay-out section 112 differs in the point that indicators 117A, 117B, 117C and 117D (referred to below collectively as indicators 117) are provided in the vicinity of the pay-out port 14A and the pay-out port 14B, however, other parts are configured similarly.

The indicators 117A and 117B are respectively disposed adjacently at the left and adjacently at the right of the pay-out port 14A on the far side. The indicators 117C and 117D are respectively disposed adjacently at the left and adjacently at the right of the pay-out port 14B on the near side.

Thus, for example, the operators MA and MB can be notified that the banknotes conveyed, or banknotes to be conveyed, to the pay-out port 14A are under a pay-out instruction of the operator MA on the left side, by illuminating or flashing the indicator 117A disposed adjacently at the left of the pay-out port 14A.

Moreover, for example, the operators MA and MB can be notified that the banknotes conveyed, or banknotes to be conveyed, to the pay-out port 14B are under a pay-out instruction of the operator MA on the left side, by illuminating or flashing the indicator 117C disposed adjacently at the left of the pay-out port 14B.

In a similar manner, the operators MA and MB can be notified that the banknotes conveyed, or banknotes to be conveyed, to the pay-out port 14A or 14B are under a pay-out instruction of the operator MB on the right side, by illuminating or flashing the indicator 117B or 117D.

In this manner, by illuminating or flashing the indicators 117 the banknote processing device 102 is able to display which of the operators MA or MB gave the operation instruction under which the banknotes were conveyed, or banknotes are to be conveyed, to the pay-out port 14A or 14B.

2-2 Processing Routine

Detailed explanation next follows regarding a pay-out processing routine and a cover opening and closing processing routine performed by the banknote processing device 102 in the banknote pay-out system 101 during pay-out processing.

The banknote processing device 102 executes pay-in processing according to a pay-in processing routine RT1 (FIG. 7 and FIG. 8) similar to that of the first exemplary embodiment. However, as described below, the banknote processing device 102 executes processing that partially differs from that of the first exemplary embodiment, only in the cover opening and closing processing called as a subroutine at step SP23.

2-2-1. Pay-Out Processing

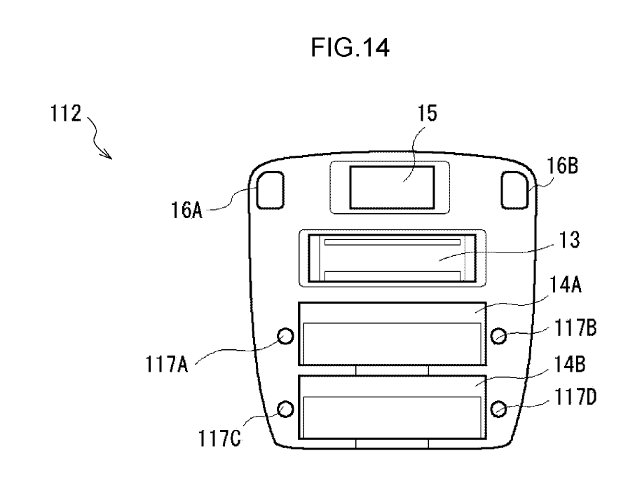

Explanation first follows regarding a pay-out processing routine, with reference to the flowchart of FIG. 15 corresponding to FIG. 10.

For example, the operators MA and MB (FIG. 2) send pay-out instructions to the banknote processing device 102 over a network 4 (FIG. 1) by operating the terminal devices 3A and 3B according to orders for pay-out procedures from customers CS. Explanation follows regarding an example of a case in which, similarly to in the first exemplary embodiment, a pay-out instruction has been transmitted from the terminal device 3B operated by the operator MB on the right side.

On receipt of the pay-out instruction from the terminal device 3 (the terminal device 3B in this case), the controller 111 of the banknote processing device 102 starts a pay-out processing routine RT4, and then transitions to step SP61. At steps SP61 to SP63, the controller 111 performs respective processing similar to that of steps SP31 to 33, and then transitions to the next step SP64.

At step SP64, the controller 111 causes the indicator 117 on the instructing terminal 3S side of the pay-out port 14A that is the selected pay-out port 14S, namely the indicator 117D that is on the right side, flash, then transitions to the next step SP65.

Then at steps SP65 to SP70, the controller 111 performs respective processing similar to that of steps SP35 to SP40, and then transitions to the next step SP71.

At step SP71, the controller 111 temporarily opens the cover CV of the pay-out port 14A that is the selected pay-out port 14S by executing cover opening and closing processing, described below, and then, after the operator MB has taken out the banknotes, transitions to the next step SP42 and ends the pay-out processing routine RT4.

2-2-2. Cover Opening and Closing Processing

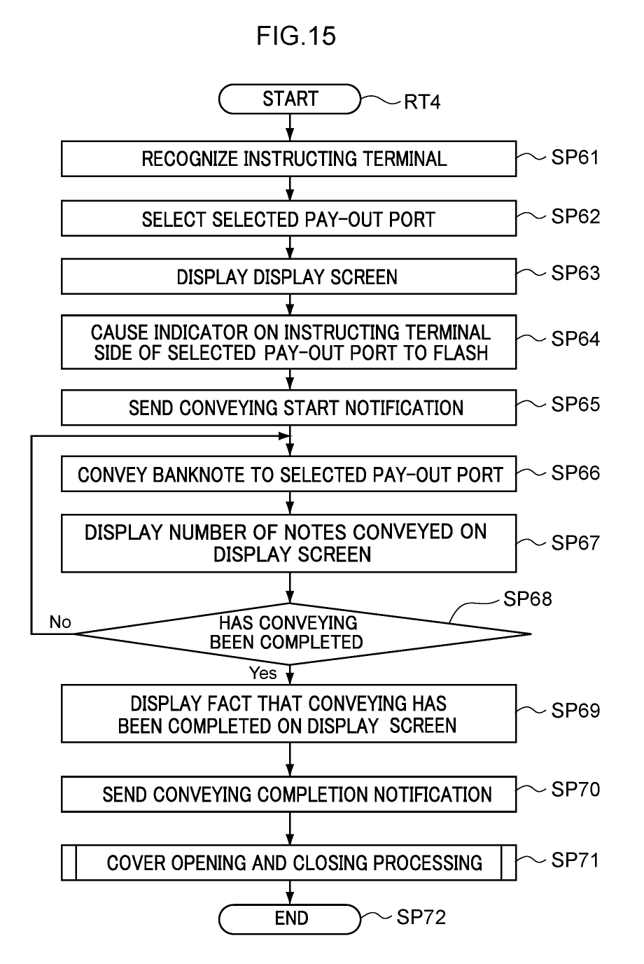

Next, explanation follows regarding the cover opening and closing processing routine the banknote processing device 102 executes as a subroutine during pay-in processing or pay-out processing, with reference to the flowchart of FIG. 16 corresponding to FIG. 13.

Explanation follows regarding a case in which the banknote processing device 102 executes pay-out processing with the pay-out port 14A as the selected pay-out port 14S under a pay-out instruction from the terminal device 3B on the right side that is the instructing terminal 3S.

In a state in which conveying of banknotes to the selected pay-out port 14S has been completed in the pay-out processing routine RT4 (FIG. 15), the controller 111 of the banknote processing device 102 transitions to step SP71, starts the cover opening and closing processing routine SRT5, and then transitions to step SP81.

At step SP81, the controller 111 causes the indicator 117 on the instructing terminal 3S side of the selected pay-out port 14S, namely the indicator 117D that is on the right side of the pay-out port 14A, to flash by periodically illuminating and extinguishing the indicator 117D, and then transitions to the next step SP82.

Then at steps SP82 to SP84, the controller 111 performs respective processing similar to that of steps SP53 to SP55, and then transitions to the next step SP85.

At step SP85, the controller 111 extinguishes the indicator 117 on the instructing terminal 3S side of the selected pay-out port 14S, namely the indicator 117D on the right side of the pay-out port 14A, and then transitions to the next step SP86.

At step SP86, the controller 111 closes off the collection space from the outside by driving the cover CV of the pay-out port 14A that is the selected pay-out port 14S so as to switch from the open state to the closed state, and then transitions to the next step SP87.

At step SP87, the controller 111 completes one cycle of processing accompanying opening and closing the cover CV of the selected pay-out port 14S by completing the cover opening and closing processing routine SRT5, and transitions to step SP71 of the original pay-out processing routine RT4 (FIG. 5).

2-3 Operation and Advantageous Effects

In the above configuration, the banknote processing device 102 of the banknote pay-out system 101 according to the second exemplary embodiment is provided with the pay-out ports 14A and 14B at two locations in the pay-in/pay-out section 12, and the respective indicators 117 (117A to 117D) are disposed on both the left and right sides of the pay-out ports 14A and 14B.

On receipt of a pay-out instruction from one of the terminal devices 3 during pay-out processing, after selecting the selected pay-out port 14S, the banknote processing device 102 displays the display screen D5 (FIG. 11A) on the display operation section 15, and illuminates the indicator 117 on the instructing terminal 3S side of the selected pay-out port 14S.

The banknote processing device 102 is thereby able to make the operators M quickly aware of which of the operators M issued the operation instruction under which banknotes are currently being conveyed, and to which out of the pay-out ports 14A and 14B the banknotes are being conveyed, without making the operators M read detailed text, marks, or the like displayed on the display operation section 15.

When conveying of banknotes to the selected pay-out port 14S has been completed, the banknote processing device 102 switches the indicator 117 on the instructing terminal 3S side of the selected pay-out port 14S from illuminated to flashing.

The banknote processing device 102 is thereby able to notify by the flashing that banknote conveying processing has been completed and a state has been achieved in which the banknotes can be taken, and by the position of the indicator 117, also enables clear awareness of which operator M (the MA or the MB) issued the pay-out instruction under which the conveying processing was performed, and from which of the pay-out ports 14A or 14B the banknotes may be taken.

Together with this, the banknote processing device 102 drives the cover CV of the selected pay-out port 14S to achieve the open state. The banknote processing device 102 is thereby able to allow the banknotes be taken from the selected pay-out port 14S without making the operator M perform any operation. The banknote processing device 102 is also capable of making the operator M aware of from which of the pay-out ports 14A or 14B the banknotes may be taken, due to the open state of the cover CV of the selected pay-out port 14S.

Even if the cover CV of one of the pay-out ports 14 remains in an open state after completion of the immediately previous pay-out processing, and the next pay-out processing is then completed and the cover CV of the other pay-out port 14 is also opened, the banknote processing device 102 is still able to intuitively show which of the operators M should take the banknotes inside each of the pay-out ports 14 by the positions of the flashing indicators 117.

Regarding other points, the banknote processing device 102 exhibits similar operation and advantageous effects to those of the banknote processing device 2 of the first exemplary embodiment.

According to the above configuration, the banknote processing device 102 of the banknote pay-out system 101 is provided with the pay-out ports 14A and 14B at two locations on the pay-in/pay-out section 12. The banknote processing device 102 is configured to indicate the correspondence between the operator M who instructed the processing being executed and the selected pay-out port 14S to which the banknotes are conveyed, and to indicate the state of progress, by using the illumination state of the indicators 117 and the display screen D displayed on the display operation section 15. Thus when performing new pay-out processing, even when the banknotes conveyed by the immediately previous pay-out processing remain in one of the pay-out ports 14, the banknote processing device 102 is able to convey banknotes to the other pay-out port 14 as the new selected pay-out port 14S without needing to wait until the first banknotes have been taken, and is able to preemptively prevent mistaken removal by the operator M in such circumstances.

### 3. Other Exemplary Embodiments

In the first exemplary embodiment described above, explanation has been given of a case in which a correspondence relationship between the pay-out port 14A or 14B and the instructing terminal 3S is indicated by display of the display screen D on the display operation section 15 and by illumination or flashing of the operation buttons 16 when pay-out processing is being performed.

However, the present invention is not limited thereto, and, for example, configuration may be made such that the correspondence relationship between the pay-out port 14A or 14B and the instructing terminal 3S is indicated by one out of display of the display screen D on the display operation section 15, or illumination or flashing of the operation buttons 16. Similar applies to the pay-in processing, and similar applies to the second exemplary embodiment.

Moreover, in the first exemplary embodiment described above, a case was given in which whether a pay-out instruction has been received from one of the operators M was indicated by displaying the directional mark MK, and displaying the text TX such as “Processing for the right” in the status box AR1 of the display screen D6 when pay-out processing is being performed.

However, the present invention is not limited thereto and, for example, a reference numeral for identification such as “T01” may be allocated in advance to each of the terminal devices 3, so as to indicate which of the operators M a pay-out instruction has been received from by displaying the reference numeral, or by various characters, symbols, graphics, or a combinations thereof. The display thereof does not need to be continuous display from the stage when the pay-out instruction was received until the point in time when the pay-out processing is complete, and it is sufficient that it is displayed at least when having the operators M take the banknotes from the pay-out port 14. Similar applies to pay-in processing, and similar applies to the second exemplary embodiment.

Moreover, in the first exemplary embodiment described above, an example has been given in which, during pay-out processing, an image depicting the pay-in/pay-out section 12 is displayed on the display screen D6 (FIG. 11B), and a location corresponding to the pay-out port 14A is colored in a different color to the other portions, and the text of “Left” or “Right” to indicate the operator M whose pay-out instruction conveying is being performed under, and text (numbers) indicating number of notes that have completed conveying and the total number of notes scheduled to be conveyed, are displayed inside the frame FA surrounding the pay-out port 14A.

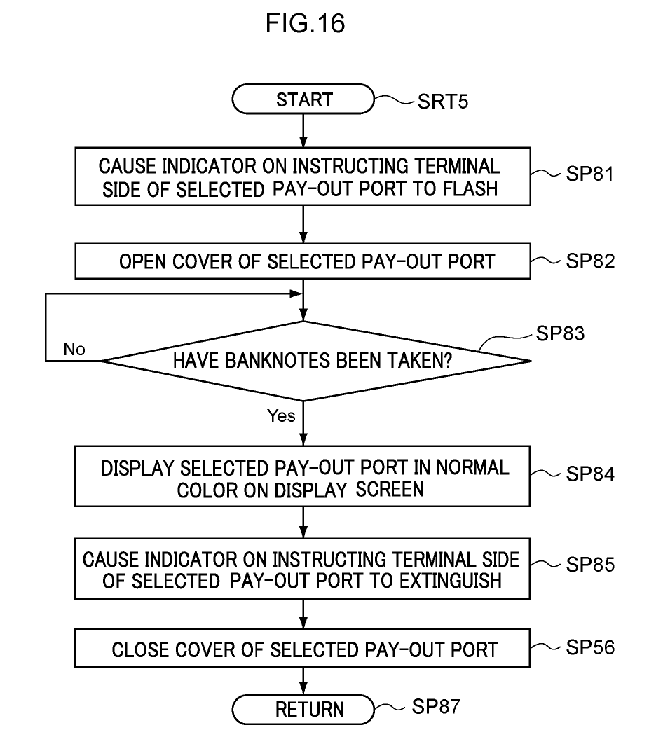

However, the present invention is not limited thereto, and, for example, names such as “upper pay-out port” and “lower pay-out port” may be pre-allocated to the pay-out ports 14A and 14B, and reference numerals such as “T01” and “T02” may be respectively allocated to the terminal devices 3A and 3B, and the name of the pay-out port, the reference numeral of the terminal device 3, and the number of notes that have completed conveying may be displayed, as on the display screen D8 illustrated in FIG. 17. Or, the respective pay-out ports 14 and their surroundings may be colored differently to each other, for example, red and blue, and these colors may be displayed on the display screen D associated with the reference numerals of the terminal devices 3.

In such cases, it is sufficient that the correspondence between each of the pay-out ports 14 and the instructing terminal 3S can be expressed by utilizing various methods of notation appropriately combining various characters, numbers, symbols, graphics, images, hue, and brightness, and relative positional relationships, changes, and the like thereof. Moreover, regarding text (numbers) expressing the number of notes that have completed conveying and the total number of notes scheduled to be conveyed, one of, or both of these items may be omitted. Similar applies to pay-in processing, and similar applies to the second exemplary embodiment.

Moreover, in the first exemplary embodiment described above, a case has been given in which the correspondence relationship between the pay-out port 14A or 14B and the instructing terminal 3S is indicated by displaying the display screen D6 (FIG. 11B), for example, on the display operation section 15 disposed at the upper center of the pay-in/pay-out section 12 using characters, images, or the like.

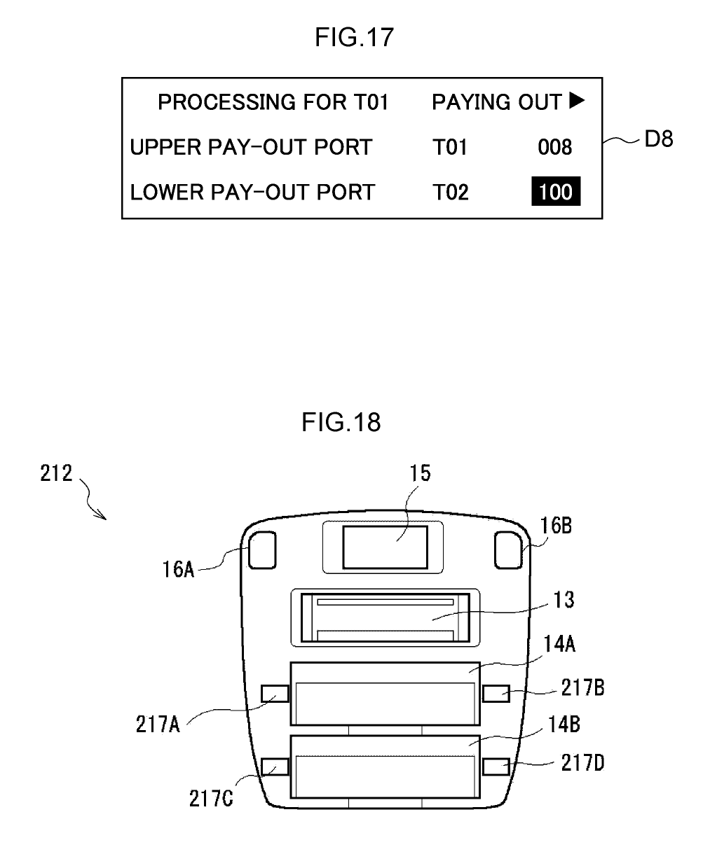

However, the present invention is not limited thereto, and, for example, as illustrated in FIG. 18, display sections 217 (217A to 217D) may be respectively disposed on a pay-in/pay-out section 212 at the left and right of the pay-out ports 14A and 14B, namely at the locations where the respective indicators 117 (117A to 117D) are disposed in the second exemplary embodiment. In such cases, the correspondence relationship between the pay-out port 14A or 14B and the instructing terminal 3S may be indicated by the display content of the display sections 217A to 217D, or by a combination of the display screen D displayed on the display operation section 15 and the display content of the display sections 217A to 217D.

More precisely, for example, a mark such as the directional mark MK (FIG. 11A to FIG. 11C) may be displayed on the display section 217 at the instructing terminal 3S side of the selected pay-out port 14S, or the number of banknotes conveyed displayed in numbers and sequentially updated. Moreover, for example, in text or symbols, such as the “x” mark, indicating the fact that the banknotes should not be taken may be displayed on the display section 217 on the opposite side of the selected pay-out port 14S to the instructing terminal 3S.

Or, for example, the correspondence relationship between the pay-out port 14A or 14B and the instructing terminal 3S may be indicated by displaying information such as characters, images, or the like using the cover CV as a screen on the appropriate cover CV by incorporating a display device in the cover CV of each pay-out port 14, or by incorporating a projection device in the pay-out ports 14.

Moreover, in the first exemplary embodiment described above a case has been given in which the operational status is displayed by characters of “paying out” and the number of banknotes conveyed to each of the pay-out ports 14, etc. on the display screen D6 (FIG. 11B) during pay-out processing.

However, the present invention is not limited thereto, and various operational statuses of the banknote processing device 2 may be displayed on the display screen D6, such as, for example, the number of banknotes stored in the banknote cassette 23 and the number of banknotes stored in the reject cassette 24, or one or more item may be omitted from the display screen D6 out of the characters of “paying out” and the number of banknotes conveyed to each of the pay-out ports 14. Similar applies to the pay-in processing, and similar applies to the second exemplary embodiment.

Moreover, in the first exemplary embodiment described above, a case was given in which, during pay-out processing, the progress bar and a percentage number expressing the state of progress are displayed in the status box AR1 of the display screen D6 (FIG. 11B), the number of notes that have completed conveying to the pay-out port 14A or 14B is displayed in the frame FA or FB, and the proportion of the colored portion and the respective numbers are successively updated according to the state of progress of conveying.

However, the present invention is not limited thereto, and, for example, the state of progress may be expressed using various graphics, such as a pie chart, or the time remaining may be displayed when it is possible to compute the time required for processing, and moreover, any or all out of the progress bar, the percentage number expressing the state of progress, and/or the number of notes that have completed conveying to the pay-out port 14A or 14B, may be omitted. The frequency of updating these may also be performed discretely, such as at every specific time interval, or at every specific number of notes, rather than successively. Similar applies to the pay-in processing, and similar applies to the second exemplary embodiment.

Moreover, in the first exemplary embodiment described above, a case has been given in which, in pay-out processing, the operation button 16 on the instructing terminal 3S side is illuminated at the point in time when banknote conveying processing starts, is caused to flash to prompt pressing of the appropriate operation button 16 when conveying processing is complete, and is illuminated again when the appropriate operation button 16 has been pressed, and the appropriate operation button 16 is extinguished at the point in time when the banknotes have been taken.

However, the present invention is not limited thereto, and configuration may be made so as to switch between illumination, flashing, and extinguishing the operation button 16 at various stages in pay-out processing, for example, such that the operation button 16 remains extinguished at the point in time banknote conveying processing starts, and is illuminated to prompt pressing of the appropriate operation button 16 when conveying processing is complete. Illumination and flashing of the operation button 16 may, for example, be accomplished by changing the brightness when illuminated, or by changing the period of flashing. In such cases, it is sufficient to at least to give awareness of which operator M issued the pay-out instruction under which the banknotes were conveyed to the selected pay-out port 14S, and also to give awareness of a state in which conveying processing is complete and the banknotes may be taken.

Moreover, in the first exemplary embodiment described above, a case was given in which light emitting devices such as LEDs are incorporated into the operation buttons 16 (16A and 16B), such that the appropriate operation button 16 itself is illuminated or caused to flash.

However, the present invention is not limited thereto, and, for example, light emitting devices such as LEDs may be disposed in the vicinity of the operation buttons 16 and the appropriate light emitting device illuminated or caused to flash, or light emitting devices may be omitted from the operation buttons 16, including the vicinity thereof.

Moreover, in the second exemplary embodiment described above, a case was given in which, in the pay-out processing, the operation buttons 16 are not particularly illuminated, and a pressing operation of the operation buttons 16 is not urged.

However, the present invention is not limited thereto, and, for example, similarly to in the first exemplary embodiment, the operation button 16 on the instructing terminal 3S side may be illuminated at the point in time when banknote conveying processing starts, and the appropriate operation button 16 may be caused to flash at the stage when conveying processing has been completed, or configuration may be made such that the cover CV of the pay-out port 14 is opened after the operation button 16 has been pressed.

Moreover, in the first exemplary embodiment described above, a case has been given in which the operation buttons 16A and 16B are disposed on the left and right of the display operation section 15.

However, the present invention is not limited thereto, and, for example, the operation buttons 16A and 16B may be disposed so as to be positioned at the left and right of the pay-in port 13 and at the left and right of the pay-out port 14A, etc., or toward the left and toward the right on the pay-in/pay-out section 12. Similar applies to the second exemplary embodiment.

In the first exemplary embodiment described above, a case was given in which light emitting devices such as LEDs are not particularly disposed on the pay-out ports 14 and their periphery, and the display mode of the pay-out ports 14 themselves is not in particular changed.

However, the present invention is not limited thereto, and, for example, part of, or all of, the pay-out ports 14 may be caused to emit light by appropriately disposing light emitting devices such as LEDs and known light guide members so as to surround the periphery of the pay-out ports 14. Or, for example, the covers CV may be configured from what is known as semitransparent material, colored to reduce light transmittance, such that the inside is not visible when the light emitting devices are extinguished, and the banknotes inside are only visible during illumination.

In such cases, the timing at which light emission starts is, for example, conceivably the point in time when banknote conveying processing has started or has been completed, and the timing when light emission is ended is, for example, conceivably a timing when the banknotes have been taken out by the operator M. Similar applies to pay-in processing, and similar applies to the second exemplary embodiment.

Moreover, in the first exemplary embodiment described above, a case was given in which, in pay-out processing, the message windows W1 and W2 (FIG. 12A and FIG. 12B) are displayed on the display screen of the instructing terminal 3S by sending a conveying start notification and a conveying completion notification from the banknote processing device 2 to the instructing terminal 3S, so as to notify the operator M of the operation status of the banknote processing device 2.

However, the present invention is not limited thereto, and, for example, one or both of sending the conveying start notification and/or sending the conveying completion notification may be omitted, or a specific message window may be displayed at another timing.

Moreover, for example in the message window W1 displayed on the display screen of the instructing terminal 3S, freely selected information from out of text explaining the operational status, an image depicting the pay-in/pay-out section 12 and the selected pay-out port 14S, text explaining the selected pay-out port 14S, the number of banknotes conveyed, etc. may be selectable for display, and other information about the operational status of the banknote processing device 2 may also be displayed in combination. Similar applies to pay-in processing, and similar applies to the second exemplary embodiment.

Moreover, explanation has been given in the first exemplary embodiment described above of a case in which, in the pay-out processing, the operators M are notified of various information through the display operation section 15 and the operation button 16 in the banknote processing device 2, and the operators M are notified of the operation status of the banknote processing device 2 through the various message windows W displayed on the display screen of the instructing terminal 3S.

However, the present invention is not limited thereto, and, for example, notification of various information to the operator M through the display operation section 15 and the operation buttons 16 of the banknote processing device 2 may be omitted, and the operational status of the banknote processing device 2 may be notified only through the various message windows W displayed on the display screen of the instructing terminal 3S. Similar applies to pay-in processing, and similar applies to the second exemplary embodiment.

Moreover, in the first exemplary embodiment described above, a case was given in which various information is notified to the operator M visually through the illumination state of the operation buttons 16 and the content of the display screen D displayed on the display operation section 15.

However, the present invention is not limited thereto, and, for example, the operator M may be notified of various information audibly, by outputting an audio announcement such as “First pay-out port for the left terminal”, or by reproducing music with a tone color or rhythm pattern pre-allocated to each of the terminal devices 3.

Or, for example, a divided configuration may be adopted such that a left side face portion and a right side face portion of the cover CV of the pay-out port 14 are drivable independently to a cover body portion, and the operator M who did not instruct pay-out processing is made physically or visually aware that banknotes should not be taken, by holding the closed state of only the side face portion on the opposite side to that of the instructing terminal 3S during opening of the cover CV. In such cases, an appropriate combination may be made with visual notification of various information. Similar applies to pay-in processing, and similar applies to the second exemplary embodiment.

Moreover, in the first exemplary embodiment described above, a case was given in which, when performing a return operation during pay-in processing, the banknotes are conveyed so as to be sorted into different pay-out ports 14 by denomination.

However, the present invention is not limited thereto, and, for example, all the banknotes to be returned may be conveyed to one pay-out port 14. This thereby enables pay-out processing utilizing the other pay-out port 14 to be executed without waiting until these banknotes are taken.

Moreover, in the first exemplary embodiment described above, a case was given in which one out of the pay-out port 14A or 14B is selected as the selected pay-out port 14S in pay-out processing, and all of the banknotes to be paid out are conveyed to the selected pay-out port 14S.

However, the present invention is not limited thereto, and, for example, the banknotes may be sorted as they are being conveyed to the pay-out ports 14A and 14B as in the return operation in pay-in processing. In such cases, for example, when sending a pay-out instruction from the terminal device 3, an instruction may be given as to whether or not to sort the banknotes, or switching performed according to the operational status such that banknote sorting is only performed in cases in which other processing is not being executed in the banknote processing device 2. Moreover, in such cases, the condition by which to sort banknotes may, for example, be by denomination, by 100 notes and the remainder, by a given number of notes, or the like. Similar applies to the second exemplary embodiment.

Moreover, in the first exemplary embodiment described above, a case was given in which there are two of the pay-out ports 14 provided on the banknote processing device 2, and the banknote processing device 2 is connected to two terminal devices 3 in the banknote pay-out system 1.

However, the present invention is not limited thereto, and three of the pay-out ports 14 may be provided to the banknote processing device 2, and the banknote processing device 2 may be connected to three or more of the terminal devices 3 in the banknote pay-out system 1. In such cases, since the position of each of the terminal devices 3 with respect to the banknote processing device 2 cannot be identified by “left side” and “right side” alone, a method may conceivably be employed in which, for example, pre-allocated reference numerals are displayed as described above.

Moreover, the present invention is not limited to the respective exemplary embodiments described above and the other embodiments described above. Namely, the present invention encompasses application to embodiments combining some or all of the respective exemplary embodiments described above and the other embodiments described above, and embodiments deriving from elements thereof.

Moreover, in the exemplary embodiments described above, cases were given in which the present invention is applied to the banknote processing device 2 that is able to execute both pay-in processing and pay-out processing.

However, the present invention is not limited thereto, and, for example, the present invention may be applied to a banknote processing device that can only execute pay-out processing.

Moreover, in the exemplary embodiments described above, cases were given in which the present invention is applied to the banknote processing device 2 that handles banknotes as the medium in transaction processing, such as pay-in processing and pay-out processing.

However, the present invention is not limited thereto, and, for example, application may be made to medium processing devices that handle various paper sheet shaped media, such as cash vouchers or securities, or cash card or entrance tickets.

Moreover, in the first exemplary embodiment described above, a case was given in which the banknote processing device 2, serving as a medium dispensing device, is configured by the banknote cassette 23 serving as a storage section, the conveying section 25 serving as a conveying section, the pay-out ports 14A and 14B serving as dispensing ports, the controller 11 serving as an instruction reception section and controller, and the display operation section 15 and the operation button 16 serving as a notification section.

However, the present invention is not limited thereto, and the medium dispensing device may be configured including storage sections, conveying sections, dispensing ports, instruction reception sections, controllers, and notification sections of various other configurations.

Moreover, in the exemplary embodiments described above, cases were given in which the banknote pay-out system 1 serving as a medium dispensing system is configured by the terminal devices 3 serving as terminal devices and the banknote processing device 2 serving as a medium dispensing device, and the banknote processing device 2 serving as a medium dispensing device is configured by the banknote cassette 23 serving as a storage section, the conveying section 25 serving as a conveying section, the pay-out ports 14A and 14B serving as dispensing ports, the controller 11 serving as an instruction reception section and controller, and the display operation section 15 and the operation button 16 serving as a notification section.

However, the present invention is not limited thereto, and the medium dispensing system may be configured from terminal devices and a medium dispensing devices of various other configurations, and the medium dispensing device may be configured including storage sections, conveying sections, dispensing ports, instruction reception sections, controllers, and notification sections of various other configurations.

All publications, patent applications and technical standards mentioned in the present specification are incorporated by reference in the present specification to the same extent as if the individual publication, patent application, or technical standard was specifically and individually indicated to be incorporated by reference.

### INDUSTRIAL APPLICABILITY

The present invention may be utilized in various devices that include plural dispensing ports and that dispense a sheet shaped medium from one of the dispensing ports under instructions from plural terminal devices.

1. A banknote processing device, comprising:
a storage section for storing a banknote;
a conveying section that conveys the banknote;
a plurality of dispensing ports that dispense the banknote;
a pay-in port in which the banknote is inserted;
a classification section that classifies the banknote inserted from the pay-in port as being either a valid banknote or a rejected banknote;
an instruction reception section that receives from a plurality of terminal devices, instructions related to dispensing a stored banknote or paying-in the banknote inserted in the pay-in port;
a controller that, when the instructions are related to dispensing the stored banknote, feeds out the stored banknote from the storage section and conveys the banknote to one of the plurality of dispensing ports using the conveying section, and when the instructions are related to paying-in the banknote inserted in the pay-in port, and when the classification section has classified the banknote as being a rejected banknote, conveys the rejected banknote to one of the plurality of dispensing ports using the conveying section; and
a single display operation section that displays a correspondence between the terminal device that the instruction related to dispensing the stored banknote or paying-in the banknote inserted in the pay-in port is received from, and a select one of the plurality of dispensing ports from which the banknote or the rejected banknote will be dispensed, so as to notify an operator that inputted the instruction, from which port the banknote or the rejected banknote will be dispensed.

2. The banknote processing device of claim 1, wherein
the display operation section displays characters, graphics, symbols, images, hue, or brightness, or a combination thereof.

3. The banknote processing device of claim 2, further comprising
operation buttons at each side of the banknote processing device, each operation button being located near a respective one of the plurality of terminal devices.

4. The banknote processing device of claim 2, further comprising
indicators or display sections at each side of the dispensing ports, each indicator or display section being located near a position of a respective one of the plurality of terminal devices are positioned.

5. The banknote processing device of claim 3, wherein
each of the plurality of dispensing ports includes a cover that transitions between an open state in which the banknote can be taken, and a closed state that restricts taking of the banknote, wherein the cover is in the closed state during conveying of the banknote; and
the cover transitions from the closed state to the open state, when the operator activates the operation button.

6. The banknote processing device of claim 2, wherein
the display operation section further displays a state of conveyance of the banknote by the conveying section.

7. The banknote processing device of claim 6, wherein
the display operation section further displays denominations of the banknotes, and a number of the banknotes that has completed conveying by the conveying section.

8. The banknote processing device of claim 6, wherein
the display operation section further displays a degree of progress based on a proportion of a number of the banknotes that has been conveyed with respect to the total number of the banknotes that should be conveyed by the conveying section.

9. The banknote processing device of claim 6, wherein
the display operation section displays for each of the plurality of dispensing ports a correspondence with the plurality of terminal devices that the instruction is received from.

10. The banknote processing device of claim 6, wherein
the display operation section updates display content according to changes in a conveying state of the banknote by the conveying section.

11. The banknote processing device of claim 6, wherein
the display operation section further displays the number of rejected banknotes and the dispensing port to which the rejected banknotes have been conveyed, if there are rejected banknotes.

12. The banknote processing device of claim 6, wherein
the display operation section further displays a number of the banknotes that has completed conveying by the conveying section.

13. The banknote processing device of claim 1, wherein
each of the plurality of dispensing ports includes a cover that transitions between an open state in which the banknote can be taken, and a closed state that restricts taking of the banknote, the cover being in the closed state during conveying of the banknote and being in the open state when conveying of the banknote is complete.

14. The banknote processing device of claim 1, wherein
the banknote processing device dispenses banknotes based on instructions from a plurality of terminal devices disposed on a left and right of the banknote processing device, wherein
the single display operation section displays information based on the instruction from a respective one of the terminal device disposed on either the right or left side of banknote processing device.
